(19) United States
(12) Patent Application Publication
(10) Pub. No.: US 2012/0292416 A1
(43) Pub. Date: Nov. 22, 2012

(54) Spinning Type Fishing Reel with Manual Bale Lock and Bale Release Mechanisms

(76) Inventor: Gary Bennis, Eau Claire, WI (US)

(21) Appl. No.: 13/351,950

(22) Filed: Jan. 17, 2012

Related U.S. Application Data
(63) Continuation-in-part of application No. 12/099,417, filed on Apr. 8, 2008, now Pat. No. 8,096,493.
(60) Provisional application No. 61/488,055, filed on May 19, 2011.

(51) Int. Cl. A01K 89/01

(52) U.S. Cl. 242/233

(57) ABSTRACT

The invention relates to a spinning-type reel with a bail release mechanism and a manually manipulated bail lock mechanism. The bail release mechanism permits detachment of a bail wire from a rotor mount without the use of a tool such that a fishing line can pass between the bail wire and the rotor mount. The bail lock mechanism permits the bail wire to be locked into an open position.

### CROSS-REFERENCE TO RELATED APPLICATIONS

This application claims priority as a continuation-in-part application of U.S. application Ser. No. 12/099,417 filed Apr. 8, 2008, titled Bail Release Mechanism for Spinning Reels, and a non-provisional of U.S. Provisional Patent Application No. 61/488,055, filed on May 19, 2011, titled Spinning-type Fishing Reel with Manual Bail Lock and Bail Release Mechanisms, the contents of both of which are incorporated herein in their entirety by reference.

### TECHNICAL FIELD

The field of the invention generally relates to spinning-type fishing reels that have a manual bail lock to ensure that the bail stays open during rigging of the fishing line to prevent the bail from accidentally shutting during rigging. The spinning-type fishing reel can separately or in combination also include a manual bail release mechanism so that the user can detach the bail from the rotor to correct improper placement of the fishing line relative to the bail without the need to cut the rigged fishing line.

### BACKGROUND

Spinning-type fishing reels are well known in the art. A spinning reel typically includes a housing; an oscillating spool at an end of the housing; a rotatable crank handle extending from the housing; a rotor which rotates about the spool by cooperative movement with the crank handle; and a bail assembly. The bail assembly is typically mounted on the rotor, and operates to guide the fishing line onto the oscillating spool upon turning of the crank handle. The rotor may include a pair of elongate rotor mounts that are positioned on opposite sides of the spool and to which the bail assembly is mounted.

The bail assembly of a spinning reel typically includes a U-shaped bail wire having each end fixedly connected to one of a pair of opposing bail ears. The bail ears are pivotally connected to the rotor mounts so that the bail wire and the bail ears can be pivoted between an open position to facilitate casting by feeding fishing line from the spool, and a closed position to facilitate reeling the fishing line on to the oscillating spool as a user turns the crank handle. In the open position, the bail wire is rotated to an angle substantially parallel to a longitudinal axis of the spool. In the closed position, the bail wire is rotated to a position substantially perpendicular to the longitudinal axis of the spool.

To facilitate the wrapping of the fishing line onto the oscillating spool, the bail assembly typically includes a line guide roller that receives and guides the fishing line onto the spool during the reeling operation. The line guide roller may be disposed between the bail wire and one of the bail ears. Alternatively, the line guide roller may be formed in one of the bail ears. The bail wire may be attached to the bail assembly adjacent the line roller, wherein the bail wire initially projects laterally outwardly from the line roller. Examples of prior art bail assemblies are disclosed in U.S. Pat. No. 6,257,513 and U.S. Pat. No. 6,056,221, each of which is incorporated herein by reference in its entirety.

To prepare the rod and reel for fishing, the user either first transfers fishing line from a spool of bulk fishing line to the spool of the fishing reel, or if the spool already has sufficient fishing line, the user rigs the rod and reel with hook, weights, swivels, floats, etc. (i.e., fishing tackle).

When transferring fishing line from a spool of bulk fishing line to the spool of the fishing reel, the user opens the bail, ties the free end of the fishing line on the empty spool of the reel, closes the bail, and rotates the crank handle of the fishing reel until sufficient fishing line has been transferred to the fishing reel spool. The user then cuts the fishing line, moves the bail from the closed to open position, pulls out sufficient line to thread the fishing line through the eyelets, or guides, on the fishing rod, starting with the eyelet nearest the fishing reel and continuing out to the eyelet at the tip of the fishing rod. The user then closes the bail so that the line is under the bail and reels up the slack.

Often the user will inadvertently forget to place the line under the bail wire. To remedy this, the user must start the process over. To avoid starting over, the user may disassemble the reel by removing screws or pins to remove the bail wire or a bail ear, properly position the fishing line under the bail wire, and reassemble the reel. However, this requires additional time and special tools. Even when fishing line is correctly installed and passing under the bail, during the threading process, the bail may be bumped and caused to close. The user must then reconfigure the bail to the open position, or the fishing line will not feed properly from the spool on the reel due to the drag setting of the reel.

In rigging the line, which can occur with a new fishing rod and full spool or when the fishing line breaks as can occur during fishing, the user moves the bail from a closed position to an open position. In the open position, the line can be freely pulled from the spool. The user pulls fishing line off of the spool, feeds the free end of the line through the eyelets on the fishing rod, starting with the eyelet nearest the fishing reel and continuing out to the eyelet at the tip of the fishing rod. The user pulls out a sufficient amount of line to have enough line on which to affix the tackle. After rigging the line, the user moves the bail back to the closed position, which permits the line to be reeled back onto the spool by the rotational movement of crank handle, which rotates the bail and rotor relative to the fixed position of the spool. Often, the user inadvertently forgets to place the line under the bail wire. The tackle must then be removed from the fishing line, the fishing line must be pulled back through the eyelets, and then the fishing line must be properly positioned under the bail wire. This process is very time consuming, and may be particularly difficult when preformed in a boat where wind may be blowing, waves may be rocking the boat, lighting conditions may be poor, and the like. Even when fishing line is correctly installed and passing under the bail, during the threading process, the bail may be bumped and caused to close. The user must then reconfigure the bail to the open position, which is also particularly difficult when performed in a boat with poor weather and lighting conditions and the like.

The inventor has determined that there are two unrelated errors that can occur during the rigging process. First, once the bail is opened, it can be accidentally closed shut when the user wishes to keep the bail open to freely pull line off of the spool. As a consequence of this error, the user cannot freely pull line off of the spool and must reopen the bail. Second, once the user has rigged the line and closed the bail, the user may realize that the fishing line has been placed on the wrong side of the bail—rather than passing under the bail before passing through the eyelets, the fishing line passes directly to the eyelets. As a consequence, the user must cut the line and rig the line a second time.

The inventor has developed two separate inventions to address these two separate unrelated problems. The inventions may be implemented in combination on a fishing reel or either may be present without the presence of the other.

The details of various embodiments of the invention are set forth in the accompanying drawings and the description below. Other features and advantages of the invention will be apparent from the description, the drawings, and the claims.

### SUMMARY OF THE INVENTION

In one general aspect, a spinning-type reel has a bail release mechanism and a manually manipulated bail lock mechanism. The reel includes a rotor and a bail assembly. The rotor has a first rotor mount and a second rotor mount. The bail assembly is attached to the rotor, the bail assembly having a first bail arm attached to the first rotor mount, a second bail arm attached to the second rotor mount, and a bail wire having ends fixedly disposed on the first bail arm and the second bail arm, the bail assembly movable between an open position and a closed position.

The readily releasable attachment device is disposed on one of the first bail arm and the second bail arm to readily releasably attach the first bail arm to the first rotor mount or the second bail arm to the second rotor mount. The first bail arm can be readily released from the first rotor mount and reattached to the first rotor mount.

The bail lock mechanism is disposed on the first rotor mount that is movable to interact with the first bail arm when the first bail arm is attached to the first rotor mount such that when the bail assembly is in the open position the bail lock mechanism can be moved to interact with the first bail arm and lock the bail assembly such that the bail assembly remains in the open position and when the bail lock mechanism is moved such that the mechanism does not interact with the first bail arm the bail assembly may be moved into the closed position.

Embodiments of the spinning-type reel may include one or more of the following features. For example, the readily releasable attachment device may be a push button mounted on one of the bail arms that interacts with the rotor mount to readily releasably attach the bail arm to the rotor mount. The readily releasable attachment device may be a movable lever mounted on one of the bail arms that interacts with the rotor mount to readily releasably attach the bail arm to the rotor mount. The readily releasable attachment device may be a movable latch extending from one of the bail arms to interact with an opening in the rotor mount to readily releasably attach the bail arm to the rotor mount.

The bail lock mechanism may be a movable element disposed on the first rotor mount that is slideable to interact with the first bail arm. The bail lock mechanism may be a movable element disposed on the first rotor mount that is rotatable to interact with the first bail arm.

The bail lock mechanism may be a movable element disposed on the first rotor mount that has a first end and a second end with the element having a bias such that the second end interacts with the first bail arm to limit movement of the bail arm. The movable element may be moved against its bias to release the second end of the element from the interaction with the first bail arm to permit movement of the bail arm.

In another general aspect there is provided a spinning type fishing reel having a bail release mechanism and an external, manually manipulated bail lock mechanism. The bail release mechanism permits detachment of a bail wire from a rotor mount without the use of a tool such that a fishing line can pass between the bail wire and the rotor mount. The bail lock mechanism permits the bail wire to be locked into an open position.

Embodiments of the invention may include one or more of the following features. For example, the reel may include a bail assembly and a rotor may include a first rotor mount and a second rotor mount.

The bail assembly may be attached to the rotor, the bail assembly having a first bail arm attached to the first rotor mount, a second bail arm attached to the second rotor mount, and a bail wire having ends fixedly disposed on the first bail arm and the second bail arm, the bail assembly movable between an open position and a closed position.

The readily releasable attachment device may be disposed on one of the first bail arm and the second bail arm to readily releasably attach the first bail arm to the first rotor mount or the second bail arm to the second rotor mount, wherein the first bail arm can be readily released from the first rotor mount and reattached to the first rotor mount.

The bail lock mechanism may be disposed on the first rotor mount and may be movable to interact with the first bail arm when the first bail arm is attached to the first rotor mount such that when the bail assembly is in the open position the bail lock mechanism can be moved to interact with the first bail arm and lock the bail assembly such that the bail assembly remains in the open position and when the bail lock mechanism is moved such that the mechanism does not interact with the first bail arm the bail assembly may be moved into the closed position. The readily releasable attachment device may be a push button mounted on one of the bail arms that interacts with the rotor mount to readily releasably attach the bail arm to the rotor mount. The readily releasable attachment device may be a movable lever mounted on one of the bail arms that interacts with the rotor mount to readily releasably attach the bail arm to the rotor mount.

The readily releasable attachment device may have a movable latch extending from one of the bail arms to interact with an opening in the rotor mount to readily releasably attach the bail arm to the rotor mount.

The bail lock mechanism may include a movable element disposed on the first rotor mount that is slideable to interact with the first bail arm. The bail lock mechanism may include a movable element disposed on the first rotor mount that is rotatable to interact with the first bail arm.

The bail lock mechanism may be a movable element disposed on the first rotor mount that has a first end and a second end with the element having a bias such that the second end interacts with the first bail arm to limit movement of the bail arm. The movable element may be moved against its bias to release the second end of the element from the interaction with the first bail arm to permit movement of the bail arm.

In any of the embodiments described above, one or more of the following features may be included. For example, the spinning-type reel may further include a second readily releasable attachment device formed on the second bail arm. The second bail arm may include a first portion fixed to the bail wire and a second portion fixed to the second rotor mount and may further include a hinge connecting the first portion and the second portion of the second bail arm. The hinge may facilitate a pivoting of the bail wire and the first portion of the second bail arm relative to the second portion of the second bail arm. The hinge may facilitate a pivoting of the bail wire and the first portion of the first bail arm to an angle substantially parallel or substantially perpendicular to a longitudinal axis of the spool.

The reel may further include a line guide roller formed on the second bail arm. The hinge may be disposed intermediate the line guide roller and the second rotor mount. The hinge may be disposed intermediate the line guide roller and the bail wire.

The readily releasable attachment device on the bail arm when attached to the rotor mount may not allow the fishing line to pass between the bail arm and the rotor mount and when released from the rotor mount will allow the fishing line to pass between the bail arm and the rotor mount.

The readily releasable attachment device may include a pair of arms resiliently opposed and having a space formed there between with one arm including a flange adjacent an end thereof to form a shoulder to cooperate with the aperture in the rotor mount.

At least one bail arm may be mounted in a generally perpendicular direction to the longitudinal axis of the rotor mount. The first and second rotor mounts may extend from the reel in a direction generally parallel to the longitudinal axis of a spool mounted to the reel. The bail wire may have a main portion and two end portions at opposite ends of the main portion, the main portion and the two end portions having a generally consistent radius over the length of the bail wire.

The spinning-type reel may further include a pivot point to permit the bail assembly to pivot about an axis parallel to the longitudinal axis of a spool shaft of the reel.

The readily releasable attachment device may permit removal of the first bail arm from the first rotor mount without a bending stress being placed on the bail wire.

In another general aspect, a bail assembly for a spinning-type fishing reel includes a first bail arm; a second bail arm spaced from said first bail arm; a bail wire having ends fixedly disposed between said first bail arm and said second bail arm; and a readily releasable attachment device disposed between the first bail arm adapted to readily releasably attach the first bail arm to a rotor of the spinning-type fishing reel, wherein the first bail arm can be readily released from the rotor and reattached to the rotor. The bail assembly may also include a bail lock mechanism to lock the bail assembly in an open position for casting or rigging the fishing line.

The bail assembly may further include a second readily releasable attachment device formed on said second bail arm. The second bail arm may includes a first portion fixed to the bail wire and a second portion adapted to be fixed to the rotor.

The bail assembly may further include a hinge connecting the first portion and the second portion of the second bail arm. The bail assembly may further include a line guide roller formed on the second bail arm. The bail assembly may further include a line guide formed on the second bail arm and a hinge is formed intermediate the line guide and the bail wire.

The attachment device may be adapted to cooperate with an aperture formed in the rotor to readily releasably attach said second bail arm thereto.

### DESCRIPTION OF THE DRAWINGS

FIG. 1 is a perspective view of a spinning-type fishing reel in accordance with an embodiment of the invention and showing a bail assembly in a closed position.

FIG. 2 is a perspective view of the fishing reel of FIG. 1 with an end of the bail assembly released from a bail ear of the reel.

FIG. 3 is a front elevational view of the bail assembly of FIGS. 1 and 2.

FIG. 4 is a perspective view of a spinning-type fishing reel in accordance with another embodiment of the invention.

FIG. 5 is a perspective view of the spinning-type fishing reel of FIG. 4 with an end of a bail assembly released from a bail ear of the reel and rotated upwardly.

FIG. 6 is a perspective view of a spinning-type fishing reel in accordance with another embodiment of the invention.

FIG. 7 is a perspective view of the spinning-type fishing reel of FIG. 6 with an end of the bail assembly released from a bail ear of the reel and rotated outwardly.

FIG. 8 is a perspective view of a spinning-type fishing reel in accordance with another embodiment of the invention.

FIG. 9 is an enlarged fragmentary cross-sectional view of a securing means in accordance with another embodiment of the invention.

FIG. 10 is an enlarged fragmentary cross-sectional view of a securing means in accordance with another embodiment of the invention.

FIG. 11 is a front elevational view of a bail assembly in accordance with another embodiment of the invention.

FIGS. 12 and 13 are perspective and side views, respectively, of another embodiment of the bail release mechanism showing an alignment key mounted on the bail ear, with the bail ear being attached to the rotor mount.

FIG. 14 is a perspective view of another embodiment of the bail release mechanism showing a rotating latch, with the bail ear being detached from the rotor mount.

FIG. 15 is an enlarged view of the bail release mechanism of FIG. 14.

FIG. 16 is another perspective view of another embodiment of the rotating latch bail release mechanism with the bail ear being detached from the rotor mount.

FIG. 17 is a perspective view of another embodiment of the bail release mechanism showing a wired snap, with the bail ear being detached from the rotor mount.

FIG. 18 is an enlarged view of the bail release mechanism of FIG. 17.

FIG. 19 is close up view of the wired snap connection of the bail release mechanism of FIG. 35.

FIG. 20 is a perspective view of another embodiment of the bail release mechanism showing a push button on the bail ear, with the bail ear being detached from the rotor mount.

FIG. 21 is an enlarged view of the bail release mechanism of FIG. 20.

FIG. 22 is a perspective view of another embodiment of the bail release mechanism showing a push button on the rotor mount, with the bail ear being detached from the rotor mount.

FIGS. 23 and 24 are perspective views of the fishing reel mounted to a fishing rod with FIG. 23 showing the bail wire in the open position and the fishing correctly placed and FIG. 24 showing the bail wire in the closed position and the fishing line correctly placed.

FIGS. 25 and 26 are perspective views of the fishing reel mounted to a fishing rod with FIG. 25 showing the bail wire in a closed position and the fishing line being incorrectly placed and FIG. 26 with the bail ear detached from the rotor mount.

FIG. 27 is a side view of fishing reel having a bail release mechanism and a cam bail lock mechanism in the unlocked position.

FIG. 28 is an enlarged view of the bail release mechanism and a bail lock mechanism of FIG. 27 in the unlocked position.

FIG. 29 is a perspective view of the fishing reel of FIG. 27 with the bail wire in the open position and the cam bail lock mechanism in the unlocked position.

FIG. 30 is an enlarged view of the bail release mechanism and a bail lock mechanism of FIG. 29 in the unlocked position.

FIG. 31 is a perspective view of the fishing reel of FIG. 27 showing the bail wire in the open position and the bail lock mechanism in the locked position.

FIG. 32 is an enlarged view of the bail release mechanism and a bail lock mechanism of FIG. 31.

FIGS. 33 and 34 are perspective and side views, respectively, of the fishing reel of FIG. 27 demonstrating the movement of opening and closing the bail wire.

FIGS. 35 and 36 are perspective views of the fishing reel of FIG. 27, with the bail wire in the open position with the bail ear detached and the cam bail lock mechanism in the unlocked position.

FIG. 37 is an enlarged view of the bail release mechanism and bail lock mechanism of the fishing reel of FIG. 36.

FIG. 38 is a perspective view of another embodiment of a bail lock mechanism showing a sliding button in the unlocked position.

FIG. 39 is an enlarged view of the sliding button mechanism of FIG. 38.

FIG. 40 is a perspective view of the sliding button bail lock mechanism showing the sliding button in the locked position.

FIG. 41 is an enlarged view of the sliding button mechanism of FIG. 40.

FIG. 42 is a perspective view of another embodiment of a bail lock mechanism showing a push button spring return in the engaged position and locking the bail in the open position.

FIG. 43 is an enlarged view of the bail lock mechanism of FIG. 42.

### DETAILED DESCRIPTION

The inventor has developed a pair of separate solutions to problems with fishing reels. The solutions are considered separate because they solve two different problems in fishing. The following detailed description and appended drawings describe and illustrate various exemplary embodiments of the invention. The description and drawings serve to enable one skilled in the art to make and use the invention, and are not intended to limit the scope of the invention in any manner.

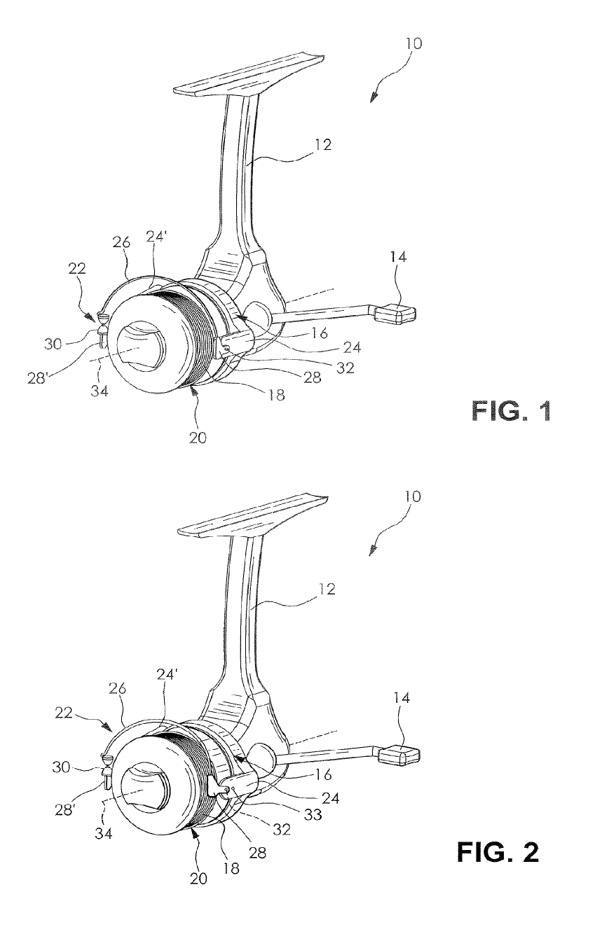

FIG. 1 illustrates a spinning-type fishing reel 10 adapted to be used with a fishing rod (not shown) according to an embodiment of the invention. The reel 10 includes a mount 12 adapted to couple the reel 10 to the rod. The reel 10 also includes a rotating crank handle 14 coupled to a rotor 16 that causes a rotation of the rotor 16. The rotor 16 facilitates a winding of fishing line 18 on a spool 20. A bail assembly 22 is mounted on rotor mounts 24, 24′ of the rotor 16. The rotor mounts 24, 24′ are formed on opposing sides of the rotor 16 and spaced from the spool 20.

The bail assembly 22 of the reel 10 includes a substantially U-shaped bail wire 26, each end of which is connected to one of a pair of bail ears 28, 28′. The bail wire 26 and bail ears 28, 28′ may be formed from a metal, a plastic, a composite material, or other conventional material, as desired. The bail ears 28, 28′ are pivotally connected to the rotor mounts 24, 24′, respectively. The pivotal connection facilitates a pivoting of the bail wire 26 and bail ears 28, 28′ between an open position and a closed position. The open position facilitates casting by allowing the fishing line 18 to de-spool from the spool 20. The closed position facilitates reeling the fishing line 18 back onto the spool 20 as a user turns the crank handle 14.

The bail assembly 22 also includes a line guide roller 30 and an attachment device 32. The line guide roller 30 is disposed adjacent one end of the bail wire 26 and is adapted to guide the fishing line 18 onto the spool 20 during reeling. As shown, the line guide roller 30 is formed on the bail ear 28′ adjacent the bail wire 26. As illustrated in FIGS. 1 and 2, the attachment device 32 is formed on the bail ear 28 of the bail assembly 22. It is understood that the attachment device 32 may alternatively be formed on the bail ear 28′, or on both the bail ears 28, 28′, as desired. The attachment device 32 is received in an aperture 33 formed in the rotor mount 24 and is adapted to readily removably attach/detach the bail assembly 22 to the rotor mount 24. As used herein, the terms “readily removably attach” and “readily removably detach” mean to substantially instantaneously attach or detach, without the assistance of a tool.

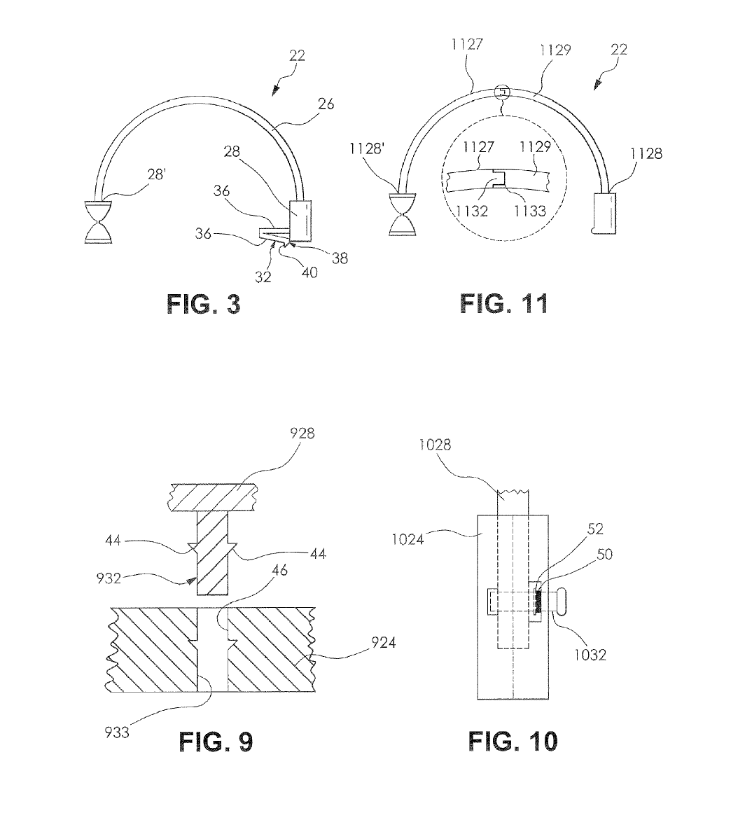

As shown in FIG. 3, the attachment device 32 is a detent extending laterally inwardly from the bail ear 28 in a direction substantially perpendicular to a longitudinal axis 34 of the spool 20. The attachment device 32 is formed from a pair of opposing detent arms 36 having a space formed therebetween. One of the ears 36 includes a flange 38 adjacent an end thereof to form a shoulder 40 thereon. The shoulder 40 is adapted to abut the rotor mount 24 adjacent the aperture 33 when the attachment device 32 is disposed in the aperture 33.

The attachment device 32 may also be formed on the bail ear 28 extending substantially parallel to the longitudinal axis 34 of the spool 20 and adapted to cooperate with an aperture formed in the rotor mount 24. It is understood that the attachment device 32 can be any attachment device adapted to readily releasably attach the bail wire 26 to one of the bail ear 28 and the rotor mount 24 such as a magnet, for example. In the embodiment shown in FIG. 3, the attachment device 32 has a substantially cylindrical shape. The attachment device 32 may have any shape as desired.

The bail ear 28′ is fixed to the rotor mount 24′ by a fastener such as a screw. The bail ear 28′ may also have a second attachment device 32 formed thereon adapted to cooperate with an aperture formed in the rotor mount 24′, similar to that described for the bail ear 28, to readily releasably attach the bail wire 26 thereto.

In use, the bail assembly 22 is attached to the rotor 16 by attaching the bail ear 28′ to the rotor mount 24′ with the fastener. The bail ear 28 is attached to the rotor mount 24 by inserting the attachment device 32 into the aperture 33 until the shoulder 40 of the flange 38 abuts the rotor mount 24. The shoulder 40 cooperates with the rotor mount 24 to militate against an unintended removal of the attachment device 32 from the aperture 33. If the user has inadvertently fed fishing line 18 from a bulk supply of fishing line (not shown) to the spool 20 over the bail wire 26, the bail ear 28 is readily detached from the rotor mount 24 by pressing the flange 38 of the arm 36 towards the other arm 36. The attachment device 32 and the bail ear 28 are then pulled outwardly from the rotor mount 24, thereby opening a space therebetween, through which the fishing line 18 may be inserted to properly position the fishing line 18 under the bail wire 26 and adjacent the line guide roller 30, as shown in FIG. 2. Because the bail wire 26 is typically formed from a flexible and elastic material, the bail wire 26 may be repeatedly pulled away from the bail ear 28 and returned to a position with the attachment device 32 disposed in the aperture 33, as desired.

The readily removable attachment device 32 facilitates an efficient re-positioning of the fishing line 18 from outside of the bail wire 26 to under the bail wire 26, without having to cut the fishing line 18 and without the assistance of a tool.

Additionally, when the user is rigging the fishing line 18, the user may adjust the reel 10 to a closed position, position the fishing line 18 over the bail wire 26 of the bail assembly 22, rig the fishing line 18, then re-position the fishing line 18 under the bail wire 26 as described herein. By rigging the fishing line 18 over the bail assembly 22, the affect of the rotation of the rotor 16 is minimized.

It is understood that a hinge mechanism can be provided at an interface between the bail wire 26 and the line guide roller 30. Additionally, a pivot limiter or stop (not shown) can be provided to militate against a pivoting of the bail wire 26 beyond a desired point. These features can be provided in combination with any of the embodiments of the invention disclosed herein without departing from the scope and spirit thereof.

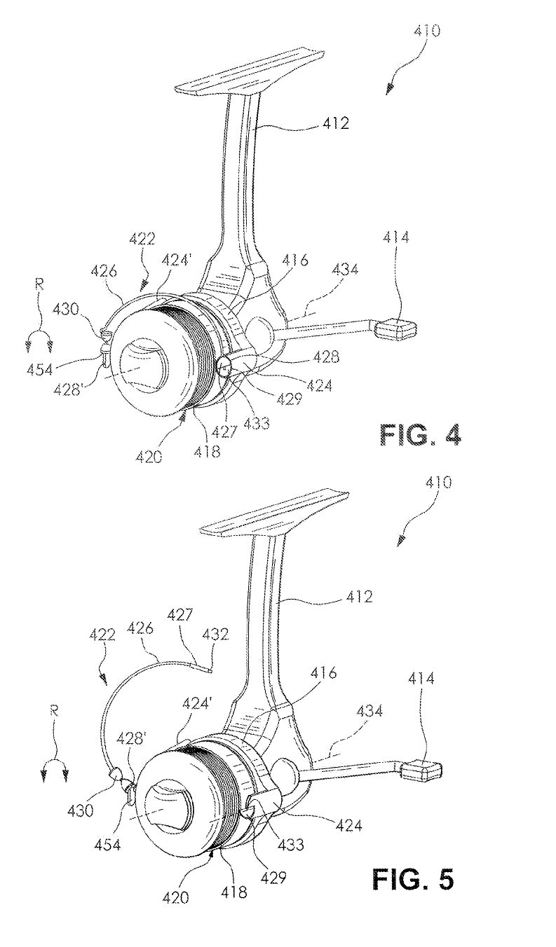

FIG. 4 illustrates a spinning-type fishing reel 410 adapted to be used with a fishing rod (not shown) according to another embodiment of the invention. The reel 410 includes a mount 412 adapted to couple the reel 410 to the rod. The reel 410 also includes a rotating crank handle 414 that causes a rotation of a rotor 416 to selectively reel-in or release fishing line 418 from a spool 420 disposed at an end of the rotor 416. A bail assembly 422 is mounted on rotor mounts 424, 424′ of the rotor 416. The rotor mounts 424, 424′ are formed on opposing sides of the rotor 416 and spaced from the spool 420.

The bail assembly 422 of the reel 410 includes a substantially U-shaped bail wire 426, each end of which is connected to one of a pair of bail ears 428, 428′. The bail wire 426 and bail ears 428, 428′ may be formed from a metal, a plastic, a composite material, or other conventional flexible material, as desired. The bail ears 428, 428′ are pivotally connected to the rotor mounts 424, 424′, respectively. The pivotal connection facilitates a pivoting of the bail wire 426 and bail ears 428, 428′ between an open position and a closed position. The open position facilitates casting by allowing the fishing line 418 to de-spool from the spool 420. The closed position facilitates reeling the fishing line 418 back onto the spool 420 as a user turns the crank handle 414. The bail ear 428 includes a first portion 427 and a second portion 429. The first portion 427 is selectively fixed to the bail wire 426, and readily releasably attached to the second portion 429 by an attachment device 432. The second portion 429 is attached to the rotor mount 424. The attachment device 432 is adapted to readily removably attach the first portion 427 to the second portion 429 of the bail ear 428′. It is understood that the attachment device 432 may be formed on the bail ear 428 and readily releasably attached to the rotor mount 424, as desired.

The bail ear 428′ includes a line guide roller 430. The line guide roller 430 is disposed adjacent one end of the bail wire 426 and is adapted to guide the fishing line 418 onto the spool 420 during reeling. The line guide roller 430 is formed on the bail ear 428′ adjacent the bail wire 426. A hinge 454 is disposed on the bail ear 428′ to facilitate a pivoting of the bail wire 426 in a direction as indicated by arrow R. The hinge 454 may be a separate hinge or a portion of the material forming the bail ear 428′, as desired.

The attachment device 432 shown includes a detent and extends between the first portion 427 and the second portion 429 of the bail ear 428 in a direction substantially perpendicular to a longitudinal axis 434 of the spool 420. The attachment device 432 is received in an aperture 433 formed in the second portion 429 of the bail ear 428. In the embodiment shown in FIG. 4, the attachment device 432 has a substantially cylindrical shape. The attachment device 432 may have any shape as desired. The bail ear 428′ may be fixed to the rotor mount 424′ by a fastener such as a screw, for example. Alternatively, the bail ear 428′ may also have an attachment device formed thereon adapted to cooperate with an aperture formed in the rotor mount 424′.

In use, the bail assembly 422 is attached to the rotor 416 by attaching the bail ears 428, 428′ to the rotor mounts 424, 424′, respectively, with fasteners. If the user has inadvertently fed fishing line 418 from a bulk supply of fishing line (not shown) to the spool 420 over the bail wire 426, the first portion 427 of the bail ear 428 is readily releasably detached from the second portion 429 of the bail ear 428 by pulling the portions 427, 429 apart. The bail wire 426 and the first portion 427 of the bail ear 428 are then pivoted upwardly about the hinge 454 away from the rotor mount 424, as shown in FIG. 5. Accordingly, a space is provided, through which the fishing line 418 may be inserted for proper positioning of the fishing line 418 under the bail wire 426. Because the first portion 427 of the bail ear 428 is readily removably coupled to the second portion 429 thereof and rotatable away from the bail ear rotor mount 424, the user may efficiently position the fishing line 418 under the bail wire 426 without having to cut the fishing line 418 and without the assistance of a tool. Additionally, when the user is rigging the fishing line 418, the user may adjust the reel 410 to a closed position, position the fishing line 418 over the bail wire 426 of the bail assembly 422. The user can then rig the fishing line 418 and re-position the fishing line 418 under the bail wire 426. By rigging the fishing line 418 with the fishing line 418 positioned over the bail wire 426, the affect of the rotation of the rotor 416 is minimized.

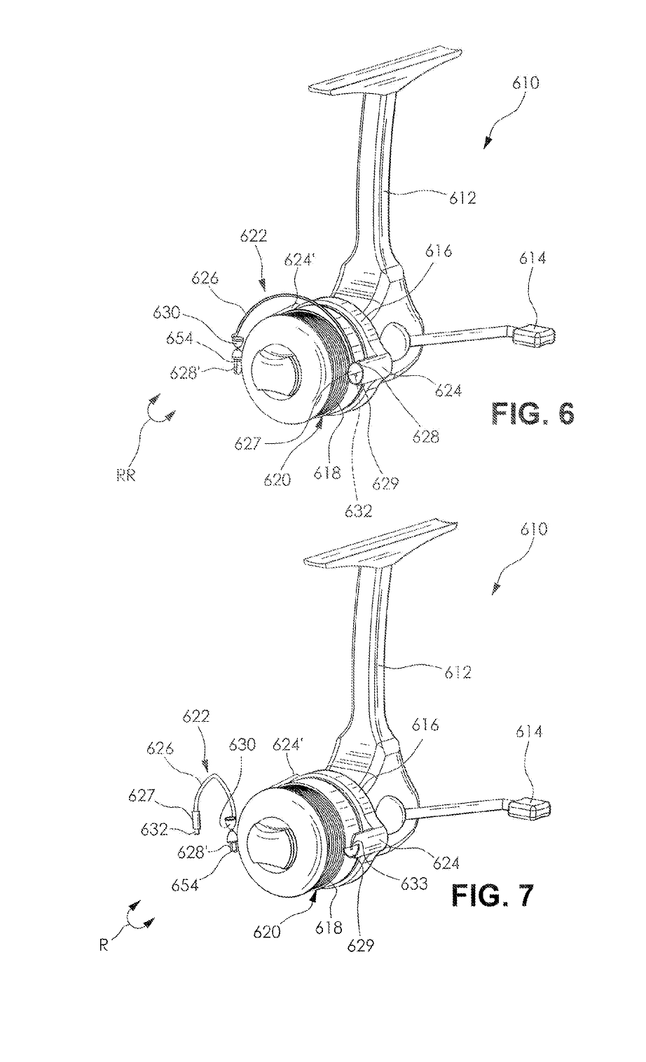

FIG. 6 is a fishing reel 610 according to another embodiment of the invention. The embodiment of FIG. 6 is similar to the fishing reel of FIGS. 4 and 5 except as provided below.

Like structure from FIGS. 4 and 5 repeated in FIG. 6 includes reference numerals in the 600s, with the last two digits the same.

A bail assembly 622 of a reel 610 includes a substantially U-shaped bail wire 626 which is connected to a pair of bail ears 628, 628′. The bail wire 626 and bail ears 628, 628′ may be formed from a metal, a plastic, a composite material, or other conventional flexible material, as desired. The bail ears 628, 628′ are pivotally connected to the rotor mounts 624, 624′, respectively, so that the bail wire 626 and bail ears 628, 628′ can be pivoted between an open position to facilitate casting, and a closed position to facilitate reeling the fishing line 618 back onto the spool 620. The bail ear 628 includes a first portion 627 and a second portion 629. The first portion 627 is fixed to the bail wire 626 and readily releasably attached to the second portion 629 by an attachment device 632. The second portion 629 is selectively fixed to the rotor mount 624. The attachment device 632 is adapted to readily removably attach the first portion 627 to the second portion 629 of the bail ear 628′.

The bail ear 628′ includes a line guide roller 630. The line guide roller 630 is adapted to guide the fishing line 618 onto the spool 620 during the reeling operation. The line guide roller 630 is formed on the bail ear 628′ adjacent the bail wire 626. A hinge 654 is disposed on the bail ear 628′ to facilitate a pivoting of the bail wire 626 in a direction as indicated by arrow RR. The hinge 626 is disposed on the bail ear 628′ adjacent the line guide 630. The hinge 654 may be a separate hinge or a portion of the material forming the bail ear 628′, as desired.

As shown in FIG. 6, the attachment device 632 includes a detent and extends downwardly from the first portion 627 of the bail ear 628 in a direction substantially perpendicular to a longitudinal axis 634 of the reel 610. The attachment device 632 cooperates with an aperture 633 formed in the second portion 629 of the bail ear 628. In the embodiment shown in FIG. 6, the attachment device 632 has a substantially cylindrical shape. The attachment device 632 may have any shape, as desired. The bail ear 628′ may be fixed to the rotor mount 624′ by a fastener such as a screw, for example, or other attachment device. Alternatively, the other bail ear 628′ may also have an attachment device formed thereon adapted to cooperate with an aperture formed in the rotor mount 624′.

In use, the bail assembly 622 is attached to the rotor 616 by attaching the bail ears 628, 628′ to the rotor mounts 624, 624′, respectively. If the user has inadvertently fed fishing line 618 from a bulk supply of fishing line (not shown) to the spool 620 over the bail wire 626, the first portion 627 of the bail ear 628 is readily releasably detached from the second portion 629 of the bail ear 628 by pulling the portions 627, 629 apart. The bail wire 626 and the first portion 627 of the bail ear 628 are then pivoted outwardly about the hinge 654 in the direction RR away from the rotor mount 624, as shown in FIG. 7, thereby providing a space in which the fishing line 618 may be disposed for proper alignment with the roller guide 630. Because the first portion 627 of the bail ear 628 is readily removably attached to the second portion 629 thereof and rotatable away from the rotor mount 624, the user may efficiently replace the fishing line 618 under the bail wire 626 without having to cut the fishing line 618 and without the assistance of a tool.

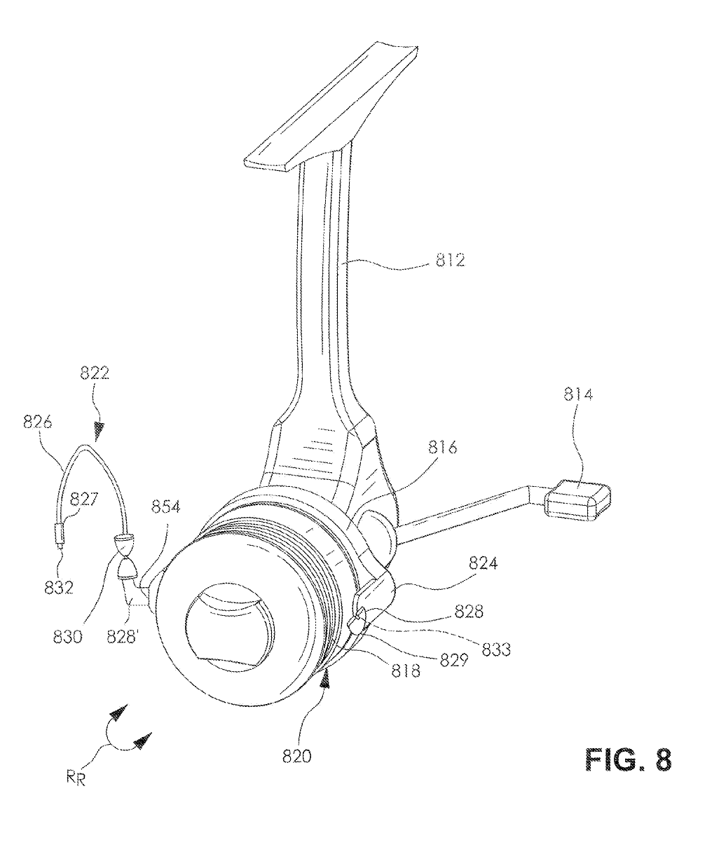

FIG. 8 is a fishing reel 810 according to another embodiment of the invention. The embodiment of FIG. 8 is similar to the fishing reel of FIGS. 6 and 7 except as provided below. Like structure from FIGS. 6 and 7 repeated in FIG. 8 includes reference numerals in the 800s, with the remaining two digits the same.

A bail assembly 822 of a reel 810 includes a substantially U-shaped bail wire 826 which is connected to a pair of bail ears 828, 828′. The bail wire 826 and bail ears 828, 828′ may be formed from a metal, a plastic, a composite material, or other conventional flexible material, as desired. The bail ears 828, 828′ are pivotally connected to the rotor mounts 824, 824′, respectively, so that the bail wire 826 and bail ears 828, 828′ can be pivoted between an open position to facilitate casting by feeding the fishing line 818 from the spool 820, and a closed position to facilitate reeling the fishing line 818 back onto the spool 820. The bail ear 828 includes a first portion 827 and a second portion 829. The first portion 827 is selectively fixed to the bail wire 826 and readily releasably attached to the second portion 829 by an attachment device 832, while the second portion 829 is selectively fixed to the rotor mount 824. The attachment device 832 is adapted to readily removably attach the first portion 827 to the second portion 829 of the bail ear 828′.

The bail ear 828′ includes a line guide roller 830. The line guide roller 830 is adapted to guide the fishing line 818 onto the spool 820 during the reeling operation. The line guide roller 830 is formed on the bail ear 828′ adjacent the bail wire 826. A hinge 854 is disposed on the bail ear 828′ to facilitate a pivoting of the bail wire 826 in a direction as indicated by arrow RR. The hinge 854 is disposed intermediate the line guide 830 and the rotor mount 824′. In the embodiment shown in FIG. 8, the hinge 854 pivotally connects the bail ear 828′ to the rotor mount 824′. The hinge 854 may be a separate hinge or a portion of the material forming the bail ear 828′, as desired.

As shown in FIG. 8, the attachment device 832 includes a detent and extends downwardly from the first portion 827 of the bail ear 828 in a direction substantially perpendicular to a longitudinal axis 834 of the reel 810. The attachment device 832 cooperates with an aperture formed in the second portion 829 of the bail ear 828. In the embodiment shown in FIG. 8, the attachment device 832 has a substantially cylindrical shape. The attachment device 832 may have any shape, as desired. The bail ear 828′ may be fixed to the rotor mount 824′ by a fastener such as a screw, for example, or other attachment device, or the other bail ear 828′ may also have an attachment device formed thereon adapted to cooperate with an aperture formed in the rotor mount 824′.

In use, the bail assembly 822 is attached to the rotor 816 by attaching the bail ears 828, 828′ to the rotor mounts 824, 824′, respectively. If the user has inadvertently fed fishing line 818 from a bulk supply of fishing line (not shown) to the spool 820 over the bail wire 826, the first portion 827 of the bail ear 828 is readily releasably detached from the second portion 829 of the bail ear 828 by pulling the portions 827, 829 apart. The bail wire 826 and the first portion 827 of the bail ear 828 are then pivoted about the hinge 854 in the direction RR away from the rotor mount 824, thereby providing a space in which the fishing line 818 may be disposed for proper alignment with the roller guide 830. Because the first portion 827 of the bail ear 828 is readily removably coupled to the second portion 829 thereof and pivotable away from the rotor mount 824, the user may efficiently replace the fishing line 818 under the bail wire 826 without having to cut the fishing line 818 and without the assistance of a tool.

FIG. 9 is an enlarged view of an attachment device 932 according to another embodiment of the invention. The attachment device 932 is formed on a bail ear 928 of a reel similar to the reel 10 of FIG. 1. The embodiment of FIG. 9 is similar to the attachment device 32 of FIGS. 2-4 except as described below. Like structure from FIGS. 2-4 repeated in FIG. 9 includes reference numerals in the 900s, with the remaining two digits the same.

As shown, the attachment device 932 includes detents and extends laterally inwardly from the bail ear 928 in a direction substantially perpendicular to a longitudinal axis of the reel. The attachment device 932 cooperates with an aperture 933 formed in a side of a rotor mount 924. It is understood that the attaching 932 may be formed on the bail ear 928 extending substantially parallel to the longitudinal axis, as desired. In the embodiments shown in FIG. 9, the attachment device 932 has a substantially cylindrical shape, but the attachment device 932 may have any shape. The attachment device 932 includes a plurality of detents 44 extending radially outwardly therefrom. The detents 44 may be formed from any flexible material such as a polymer, for example. The detents 44 are adapted to cooperate with a groove or indentation 46 formed in the walls forming the aperture 933 formed in the rotor mount 924 to readily releasably attach the attachment device 932 to the rotor mount 924.

In use, the bail assembly is attached to a rotor by attaching a second bail ear to a second rotor mount. The bail ear 928 is then attached to the rotor mount 924 by pressing the attachment device 932 into the aperture 933 of the rotor mount 924 until the detents 44 are disposed in the groove 46. The attachment device 932 may form a friction fit with the walls forming the aperture 933, as desired. If the user has inadvertently fed fishing line from a bulk supply of fishing line (not shown) the spool over a bail wire, the bail ear 928 is readily removably detached from the rotor mount 924. To readily detach the bail ear 928, the bail ear 928 is pulled outwardly away from the rotor mount 924. Because the detents 44 of the attachment device 932 are formed from a flexible material, the detents 44 deflect in a direction opposite of the direction from which the bail ear 928 is pulled, thereby disengaging the protuberances 44 from the groove 46.

The attachment device 932 and bail ear 928 are then pulled away from the rotor mount 924, thereby providing a space therebetween in which the fishing line may be inserted for proper alignment with a line guide roller. It is understood that the bail wire and/or second bail ear may be pivotable about an axis substantially perpendicular to the longitudinal axis of the reel to facilitate the pivoting of the bail wire away from the rotor when the bail ear 928 is detached from the rotor mount 924.

FIG. 10 shows an attachment device 1032 according to another embodiment of the invention. The attachment device 1032 is formed on a bail ear 1028 of a reel similar to the reel 10 of FIG. 1. The embodiment of FIG. 10 is similar to the attachment device 32 of FIGS. 2-4 except as described below. Like structure from FIGS. 2-4 repeated in FIG. 10 includes reference numerals in the 1000s, with the remaining two digits the same.

As shown, the attachment device 1032 is a spring-biased pin adapted to readily releasably attach a two-piece rotor mount 1024 to the bail ear 1028. The attachment device 1032 includes a spring 50 and a flange 52 adapted to militate against complete removal of the attachment device 1032 from an aperture 1033 formed in the rotor mount 1024. The flange 52 is formed from a flexible material to facilitate installation of the attachment device 1032. In the embodiment shown in FIG. 10, the attachment device 1032 has a substantially cylindrical shape. The attachment device 1032 may have any shape, as desired.

In use, the spring 50 is disposed in the rotor mount 1024. The attachment device 1032 is pushed through the aperture 1033 formed in the rotor mount 1024, thereby deflecting the flange 52. Once the flange 52 has passed through the aperture 1033, the flange 52 returns to an undeflected position. The spring 50 is then disposed intermediate the flange 52 and the rotor mount 1024. The rotor mount 1024 is then assembled. In the embodiment shown, the attachment device 1032 is disposed through the aperture 1033 at an angle substantially perpendicular to the longitudinal axis of the spool. It is understood that the attachment device 1032 may be formed on the bail ear 1028 extending substantially parallel to the longitudinal axis, as desired. The attachment device 1032 is pulled outwardly away from the rotor mount 1024, and the bail ear 1028 is pushed downwardly into the aperture 1033. The attachment device 1032 is then released and is slidably positioned through the aperture 1033 formed in the bail ear 1028, thereby militating against the removal thereof from the rotor mount 1024.

If the user has inadvertently fed fishing line from the bulk supply of fishing line to a spool of the reel over a bail wire, the bail ear 1028 is readily releasably detached from the rotor mount 1024 by pulling the attachment device 1032 outwardly away from the rotor mount 1024. Once the attachment device 1032 is removed from the aperture 1033 formed in the bail ear 1028, the bail ear 1028 may be removed from the rotor mount 1024. The attachment device 1032 is then released by the user and a force caused by the spring 50 on the flange 52 draws the attachment device 1032 back into rotor mount 1024. Because the bail ear 1028 is readily removably coupled to a rotor of the reel, the user may efficiently dispose the fishing line under the bail wire without having to cut the fishing line and without the assistance of a tool.

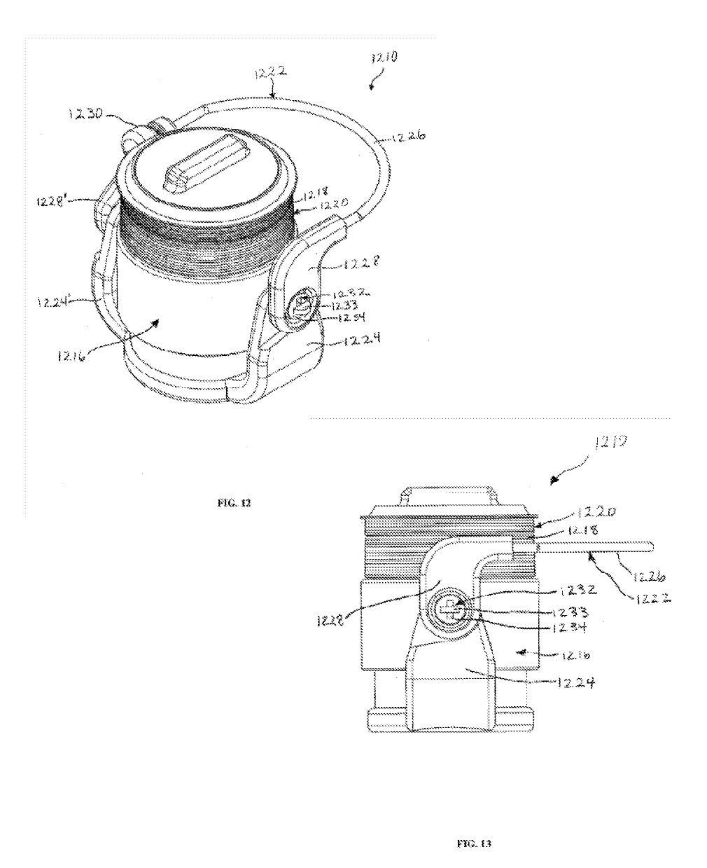

FIG. 11 illustrates a bail assembly 1122 according to another embodiment of the invention. The bail assembly 1122 disposed on a reel similar to the reel 10 of FIG. 1. The embodiment of FIG. 11 is similar to bail assembly 1122 of FIGS. 2-4 except as described below. Like structure from FIGS. 2-4 repeated in FIG. 11 includes reference numerals in the 1100s, with the remaining two digits the same.

The bail assembly 1122 is mounted on opposing rotor mounts of a rotor of the reel. The bail assembly 1122 includes a substantially U-shaped bail wire 1126 that is connected to a pair of bail ears 1128, 1128′. The bail wire 1126 includes a first portion 1127 and a second portion 1129 readily releasably attached thereto. The bail ears 1128, 1128′ are pivotally connected to the rotor mounts, respectively, so that the bail wire 1126 and bail ears 1128, 1128′ can be pivoted between an open position to facilitate casting by feeding fishing line from a spool, and a closed position to facilitate reeling the fishing line back onto the spool.

The bail assembly 1122 also includes a line guide roller and an attachment device 1132. As illustrated in FIG. 11, the attachment device 1132 is formed on an end of the first portion 1127 of the bail wire 1126 and extends laterally outwardly therefrom. The attachment device 1132 is adapted to cooperate with an aperture 1133 formed in an end of the second portion 1129 of the bail wire 1126. The attachment device 1132 and the aperture 1133 may be formed anywhere on the first portion 1127 and/or the second portion 1129, as desired. In the embodiment shown, the attachment device 1132 includes a detent and has a cylindrical shape. The aperture 1133 has a shape corresponding to that of the attachment device 1132. The attachment device 1132 may be a magnet adapted to readily releasably attach the first portion 1127 to a metal portion of the second portion 1129. It is understood that the attachment device 1132 may include a protuberance or tab adapted to cooperate with a groove or indentation in the walls forming the aperture 1133, as desired. It is also understood that the attachment device 1132 may include a button or other spring biased mechanism for readily removably attaching and detaching the portions 1127, 1129.

In use, the bail assembly 1122 is attached to the rotor by attaching the bail ears 1128, 1128′ to the rotor mounts. The first portion 1127 of the bail wire 1126 is readily releasably attached to the second portion 1129 thereof by positioning the attachment device 1132 in the aperture 1133. The attachment device 1132 forms a friction fit with the walls of the second portion 1129 forming the aperture 1133, thereby militating against the removal thereof. If the user has inadvertently fed fishing line from a bulk supply of fishing line to the spool over the bail wire 1126, the first portion 1127 of the bail wire 1126 is readily detached from the second portion 1129 thereof to provide a space therebetween in which the fishing line may be disposed for proper alignment. It is understood that the first portion 1127 and the second portion 1129 may be pivotable about the bail ears 1128′, 1128, respectively, to provide a larger space therebetween, as desired. Because the bail wire 1126 is readily removably coupled to the rotor, the user may efficiently replace the fishing line under the bail wire 1126 without having to cut the fishing line and without the assistance of a tool.

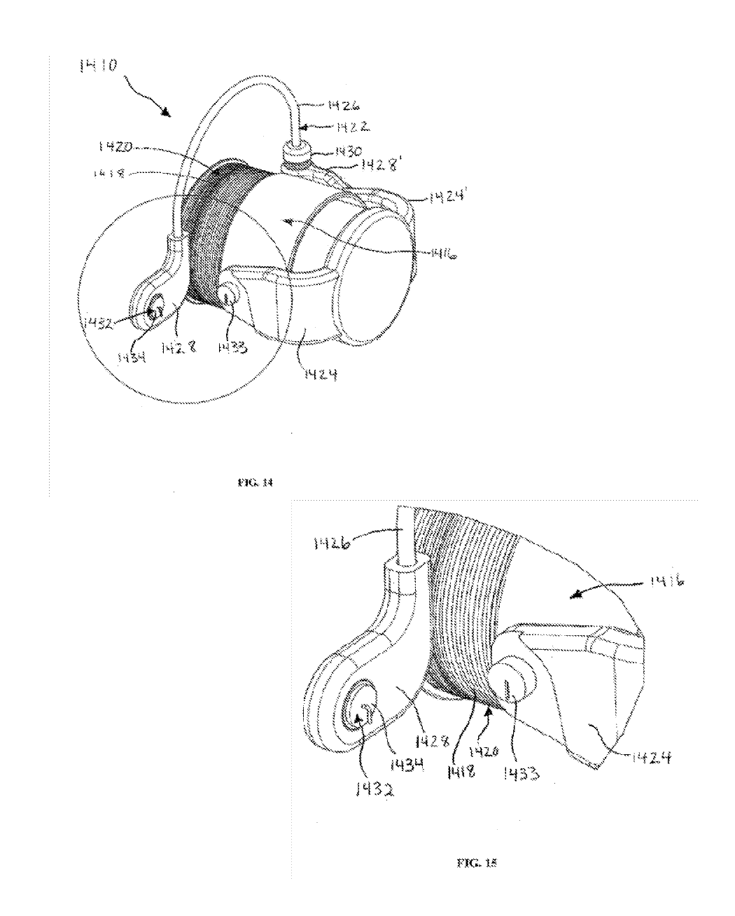

FIGS. 12 and 13 are a fishing reel 1210 according to another embodiment of the invention. The embodiment of FIG. 12 is similar to the fishing reel of FIGS. 1 and 2 except as provided below. Like structure from FIGS. 1 and 2 repeated in FIG. 12 includes reference numerals in the 1200s, with the last two digits the same.

A bail assembly 1222 of a reel 1210 includes a substantially U-shaped bail wire 1226 that is fixedly connected to a pair of bail ears 1228, 1228′. The bail wire 1226 and bail ears 1228, 1228′ may be formed from a metal, a plastic, a composite material, or other conventional rigid or flexible material, as desired. The bail ears 1228, 1228′ are pivotally connected to the rotor mounts 1224, 1224′, respectively, so that the bail wire 1226 and bail ears 1228, 1228′ can be pivoted between an open position to facilitate casting, and a closed position to facilitate reeling the fishing line 1218 back onto the spool 1220. The bail ear 1228 includes a portion 1234 that has a slot. The rotor mount 1224 has a portion 1233 that has a rotatable protrusion that may be in the form of a key, a tab or other form, as desired. The key or tab 1233 passes through the slot in portion 1234. The portion 1234 that is fixed to the bail ear 1228 is readily releasably attached to the portion 1233 that is fixed to the rotor mount 1224 by an alignment key attachment device 1232. The portion 1233 is selectively fixed to the rotor mount 1224. The attachment device 1232 is adapted to readily removably attach the portion 1234 to the portion 1233.

In use, the bail assembly 1222 is attached to the rotor 1216 by attaching the bail ears 1228, 1228′ to the rotor mounts 1224, 1224′, respectively. If the user has inadvertently fed fishing line 1218 to or from the spool 1220 over the bail wire 1226, the portion 1234 of the bail ear 1228 is readily releasably detached from the portion 1233 of the rotor mount 1224 by rotating the portion 1233 so that it aligns the slot of portion 1234. The user can pull the bail ear 1228 outward, away from the spool 1220 such that the portion 1233 passes through the slot of portion 1234 and releasably removes the bail ear 1228 from the rotor mount 1224, thereby providing a space in which the fishing line 1218 may be disposed for proper placement under the bail wire 1226. Because the portion 1234 of the bail ear 1228 is readily removably attached to the portion 1233 of the rotor mount 1224 thereof, the user may efficiently replace the fishing line 1218 under the bail wire 1226 without having to cut the fishing line 1218 and without the assistance of a tool.

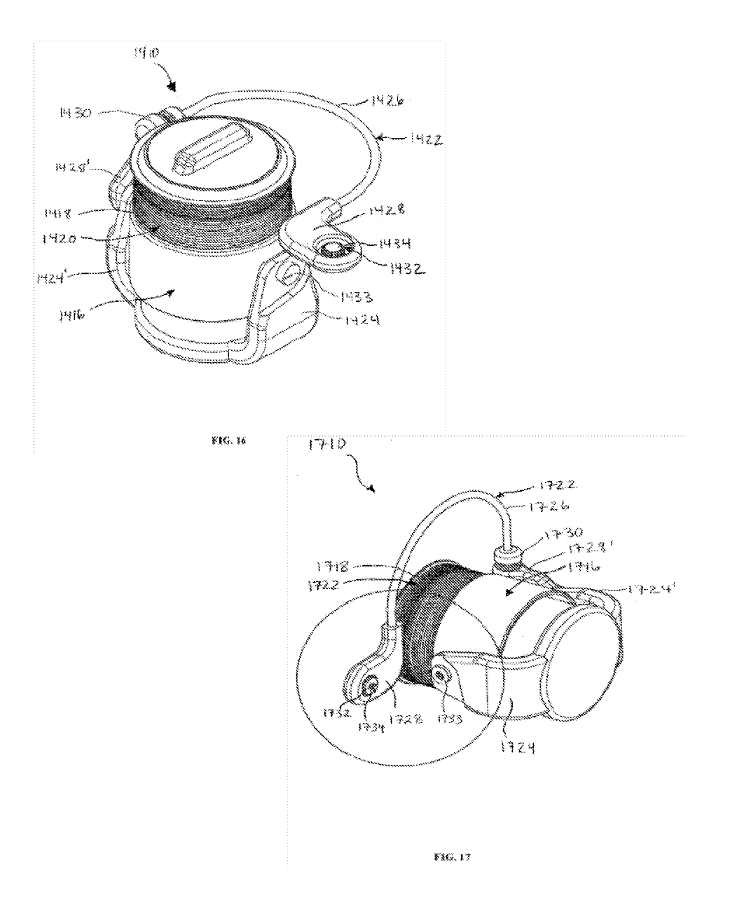

FIGS. 14 through 16 are a fishing reel 1410 according to another embodiment of the invention. The embodiment of FIGS. 14 through 16 is similar to the fishing reel of FIGS. 12 and 13 except as provided below. Like structure from FIGS. 12 and 13 repeated in FIGS. 14 through 16 includes reference numerals in the 1400s, with the last two digits the same.

A bail assembly 1422 of a reel 1410 includes a substantially U-shaped bail wire 1426 that is fixedly connected to a pair of bail ears 1428, 1428′. The bail wire 1426 and bail ears 1428, 1428′ may be formed from a metal, a plastic, a composite material, or other conventional rigid or flexible material, as desired. The bail ears 1428, 1428′ are pivotally connected to the rotor mounts 1424, 1424′, respectively, so that the bail wire 1426 and bail ears 1428, 1428′ can be pivoted between an open position to facilitate casting, and a closed position to facilitate reeling the fishing line 1418 back onto the spool 1420. The bail ear 1428 includes a portion 1434 that has a rotatable latch on the interior side and a means of manually rotating the latch from the exterior of the bail ear 1428. The rotor mount 1424 has a portion 1433 that has a slot. The portion 1434 that is fixed to the bail ear 1428 is readily releasably attached to the portion 1433 that is fixed to the rotor mount 1424 by a rotating latch attachment device 1432. The portion 1433 is selectively fixed to the rotor mount 1424. The attachment device 1432 is adapted to readily removably attach the portion 1434 to the portion 1433 by permitting the latch of portion 1434 to be aligned with the slot of portion 1433, the latch inserted into the slot, and then the latch attachment device 1432 rotated such that the latch within the slot it misaligned with the slot so that it cannot be removed from the slot. In this manner, the bail ear 1428 is attached to the rotor mount 1424.

It should be understood that the embodiment of FIGS. 12 and 13 can be configured to have some of the features of FIGS. 14-16. Specifically, FIGS. 12 and 13 may be configured such that the tab 1233 is not passed through the slot of 1234 but instead may be rotated within the slot such that a similar latch attached to the tab 1233 may be aligned or misaligned with a slot in the rotor mount. In this manner, when the slot and latch are aligned, the bail ear may be removed from the rotor mount and when they are inserted but misaligned, the bail ear and rotor mount are attached to each other.

Referring again to FIGS. 14-16, in use, the bail assembly 1422 is attached to the rotor 1416 by attaching the bail ears 1428, 1428′ to the rotor mounts 1424, 1424′, respectively. If the user has inadvertently fed fishing line 1418 to or from the spool 1420 over the bail wire 1426, the portion 1434 of the bail ear 1428 is readily releasably detached from the portion 1433 of the rotor mount 1424 by rotating the exterior portion 1434 so that the interior latch of the portion 1434 aligns with the slot of the portion 1433 attached to the rotor mount 1424. The user can pull the bail ear 1428 outward, away from the spool 1420 such that the latch of the portion 1434 fixed to the bail ear 1428 passes through the slot of portion 1433 and releasably removes the bail ear 1428 from the rotor mount 1424, thereby providing a space in which the fishing line 1418 may be disposed for proper placement under the bail wire 1426. Because the portion 1434 of the bail ear 1428 is readily removably attached to the portion 1433 of the rotor mount 1424 thereof, the user may easily place the fishing line 1418 under the bail wire 1426 without having to cut the fishing line 1418 and without the assistance of a tool.

It should be noted that the bail ears 1228 and 1428 may be rigidly fixed to the bail wire or rotatably fixed to the bail wire. For example, FIG. 14 illustrates the bail ear 1428 being moved away from the rotor mount with the bail ear also being rotated but fixed to the bail wire. This feature is option and may be used to ensure easy access for passing a fishing line underneath the bail wire by moving the bail ear clearly out of the way.

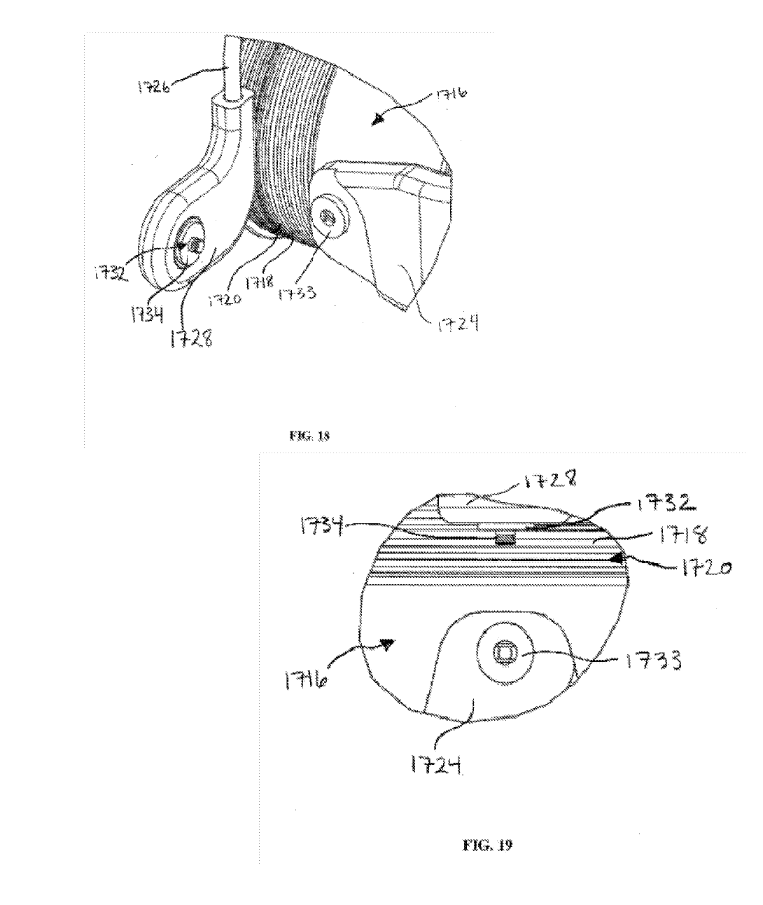

FIGS. 17 through 19 are a fishing reel 1710 according to another embodiment of the invention. The embodiment of FIGS. 17 through 19 is similar to the fishing reel of FIGS. 14 through 16 except as provided below. Like structure from FIGS. 14 through 16 repeated in FIGS. 17 through 19 includes reference numerals in the 1700s, with the last two digits the same.

A bail assembly 1722 of a reel 1710 includes a substantially U-shaped bail wire 1726 that is fixedly connected to a pair of bail ears 1728, 1728′. The bail wire 1726 and bail ears 1728, 1728′ may be formed from a metal, a plastic, a composite material, or other conventional rigid or flexible material, as desired. The bail ears 1728, 1728′ are pivotally connected to the rotor mounts 1724, 1724′, respectively, so that the bail wire 1726 and bail ears 1728, 1728′ can be pivoted between an open position to facilitate casting, and a closed position to facilitate reeling the fishing line 1718 back onto the spool 1720. The bail ear 1728 includes a portion 1734 that has a protruding snap on the interior side. The rotor mount 1724 has a portion 1733 that has an indentation designed to pair with the protruding snap portion 1734 of the bail ear 1728. The portion 1734 that is fixed to the bail ear 1728 is readily releasably attached to the portion 1733 that is fixed to the rotor mount 1724 by a wired snap attachment device 1732. The portion 1733 is fixed to the rotor mount 1724. The attachment device 1732 is adapted to readily removably attach the portion 1734 to the portion 1733. The attachment can be compared to a quick connect connection with the snap portion 1734 being retained within the portion 1733 by one or more rigid wires or other means that restrict the inner diameter of the portion 1733 but are yet flexible enough for the snap portion to be forcibly inserted and forcibly removed.

In use, the bail assembly 1722 is attached to the rotor 1716 by attaching the bail ears 1728, 1728′ to the rotor mounts 1724, 1724′, respectively. If the user has inadvertently fed fishing line 1718 to or from the spool 1720 over the bail wire 1726, the portion 1734 of the bail ear 1728 is readily releasably detached from the portion 1733 of the rotor mount 1724 by pulling outward on the portion 1734 attached to the bail ear 1728 so that the portion 1734 pops out and separates from the portion 1733 attached to the rotor mount 1724. The user can pull the bail ear 1728 outward, away from the spool 1720 such that the protrusion of the portion 1734 fixed to the bail ear 1728 pops loose from the indentation of the portion 1733 attached to the rotor mount 1724 and releasably removes the bail ear 1728 from the rotor mount 1724, thereby providing a space in which the fishing line 1718 may be disposed for proper placement under the bail wire 1726. Because the portion 1734 of the bail ear 1728 is readily removably attached to the portion 1733 of the rotor mount 1724, the user may easily replace the fishing line 1718 under the bail wire 1726 without having to cut the fishing line 1718 and without the assistance of a tool.

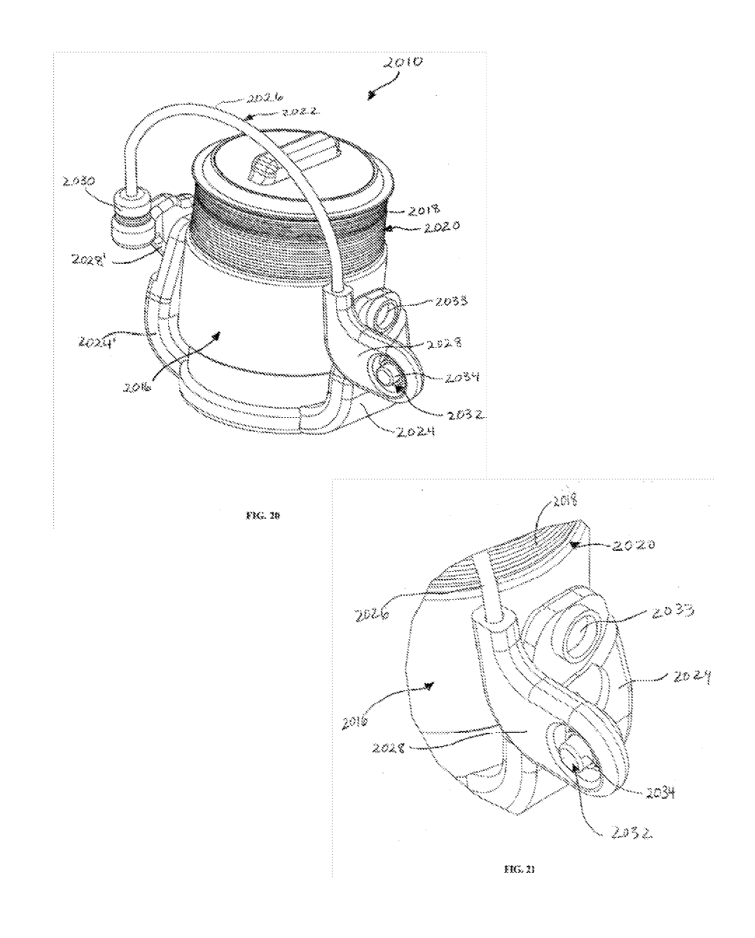

FIGS. 20 and 21 are a fishing reel 2010 according to another embodiment of the invention. The embodiment of FIGS. 20 and 21 is similar to the fishing reel of FIGS. 17 through 19 except as provided below. Like structure from FIGS. 17 through 19 repeated in FIGS. 20 and 21 includes reference numerals in the 2000s, with the last two digits the same.

A bail assembly 2022 of a reel 2010 includes a substantially U-shaped bail wire 2026 that is fixedly connected to a pair of bail ears 2028, 2028′. The bail wire 2026 and bail ears 2028, 2028′ may be formed from a metal, a plastic, a composite material, or other conventional rigid or flexible material, as desired. The bail ears 2028, 2028′ are pivotally connected to the rotor mounts 2024, 2024′, respectively, so that the bail wire 2026 and bail ears 2028, 2028′ can be pivoted between an open position to facilitate casting, and a closed position to facilitate reeling the fishing line 2018 back onto the spool 2020. The bail ear 2028 includes a portion 2034 that has a protruding button on the interior side. The rotor mount 2024 has a portion 2033 that has a receptacle designed to pair with the protruding portion 2034 of the bail ear 2028. The portion 2034 that is fixed to the bail ear 2028 is readily releasably attached to the portion 2033 that is fixed to the rotor mount 2024 by a push button attachment device 2032. The portion 2033 is selectively fixed to the rotor mount 2024. The attachment device 2032 is adapted to readily removably attach the portion 2034 to the portion 2033.

As might be expected, a number of conventional push button attachment means are possible in this configuration. For example, the push button 2032 can be pressed to expand the diameter or reduce the diameter of a part that fits within the portion 2033. The portion 2033 may be configured to have a lip, flange or other shape to allow attachment and detachment of the push button 2032. Such interacting configurations are well known in the art and are not given in detail here.

In use, the bail assembly 2022 is attached to the rotor 2016 by attaching the bail ears 2028, 2028′ to the rotor mounts 2024, 2024′, respectively. If the user has inadvertently fed fishing line 2018 to or from the spool 2020 over the bail wire 2026, the portion 2034 of the bail ear 2028 is readily releasably detached from the portion 2033 of the rotor mount 2024 by depressing the portion 2034 attached to the bail ear 2028 and pulling outward on the bail ear 2028 so that the portion 2034 separates from the portion 2033 attached to the rotor mount 2024. The user can pull the bail ear 2028 outward, away from the spool 2020 such that the portion 2034 fixed to the bail ear 2028 separates from the receptacle of the portion 2033 attached to the rotor mount 2024 and releasably removes the bail ear 2028 from the rotor mount 2024, thereby providing a space in which the fishing line 2018 may be passed for proper placement under the bail wire 2026. Because the portion 2034 of the bail ear 2028 is readily removably attached to the portion 2033 of the rotor mount 2024, the user may easily pass the fishing line 2018 under the bail wire 2026 without having to cut the fishing line 2018 and without the assistance of a tool.

FIG. 22 is a fishing reel 2010 according to another embodiment of the invention. The embodiment of FIG. 22 is similar to the fishing reel of FIGS. 20 and 21 except as provided below. Like structure from FIGS. 17 through 19 repeated in FIGS. 20 and 21 includes reference numerals in the 2200s, with the last two digits the same.

A bail assembly 2222 of a reel 2210 includes a substantially U-shaped bail wire 2226 that is fixedly connected to a pair of bail ears 2228, 2228′. The bail wire 2226 and bail ears 2228, 2228′ may be formed from a metal, a plastic, a composite material, or other conventional rigid or flexible material, as desired. The bail ears 2228, 2228′ are pivotally connected to the rotor mounts 2224, 2224′, respectively, so that the bail wire 2226 and bail ears 2228, 2228′ can be pivoted between an open position to facilitate casting, and a closed position to facilitate reeling the fishing line 2218 back onto the spool 2222. The bail ear 2228 includes a portion 2234 that has a receptacle on the interior side. The rotor mount 2224 has a protruding portion 2233 that is designed to mate with the receptacle of portion 2234 of the bail ear 2228. The portion 2234 that is fixed to the bail ear 2228 is readily releasably attached to the portion 2233 that is fixed to the rotor mount 2224 by a push button attachment device 2232. The portion 2233 is fixed to the rotor mount 2224. The attachment device 2232 is adapted to readily removably attach the portion 2234 to the portion 2233. For example, there may be an interference fit between the portion 2233 and the portion 2234 based on small outwardly extending prongs extending from the portion 2233.

In use, the bail assembly 2222 is attached to the rotor 2216 by attaching the bail ears 2228, 2228′ to the rotor mounts 2224, 2224′, respectively. If the user has inadvertently fed fishing line 2218 to or from the spool 2222 over the bail wire 2226, the portion 2234 of the bail ear 2228 is readily releasably detached from the portion 2233 of the rotor mount 2224 by depressing the portion 2233 attached to the rotor mount 2224 and pulling outward on the bail ear 2228 so that the portion 2234 separates from the portion 2233 attached to the rotor mount 2224. The user can pull the bail ear 2228 outward, away from the spool 2222 such that the receptacle of portion 2234 fixed to the bail ear 2228 separates from the protruding portion 2233 attached to the rotor mount 2224 and releasably removes the bail ear 2228 from the rotor mount 2224, thereby providing a space in which the fishing line 2218 may be passed for proper placement under the bail wire 2226. Because the portion 2234 of the bail ear 2228 is readily removably attached to the portion 2233 of the rotor mount 2224 thereof, the user may easily place the fishing line 2218 under the bail wire 2226 without having to cut the fishing line 2218 and without the assistance of a tool.

It should be understood that a number of embodiments have been shown for attaching a bail ear to a rotor mount, but any attachment means is possible. For example, the attachment means can be those described herein as well as any push button system, a rotating level system, a sliding mechanism system, or other system that causes a latch, button, prong, flange, bearing, or other surface to engage and release a mating portion on the rotor mount. Therefore, the inventor specifically intends that the means for attaching the bail ear to the rotor mount not be limited to those means disclosed herein.

FIGS. 23 through 26 are a fishing rod and reel 2310 according to any number of embodiments of the bail release invention described in the preceding discussions or equivalent to those embodiments. The fishing reel 2310 of FIGS. 23 through 26 is similar to the fishing reel of FIGS. 1-22 except as provided below. Like structure from FIGS. 1-22 repeated in FIGS. 23 through 26 includes reference numerals in the 2300s, with the last two digits the same.

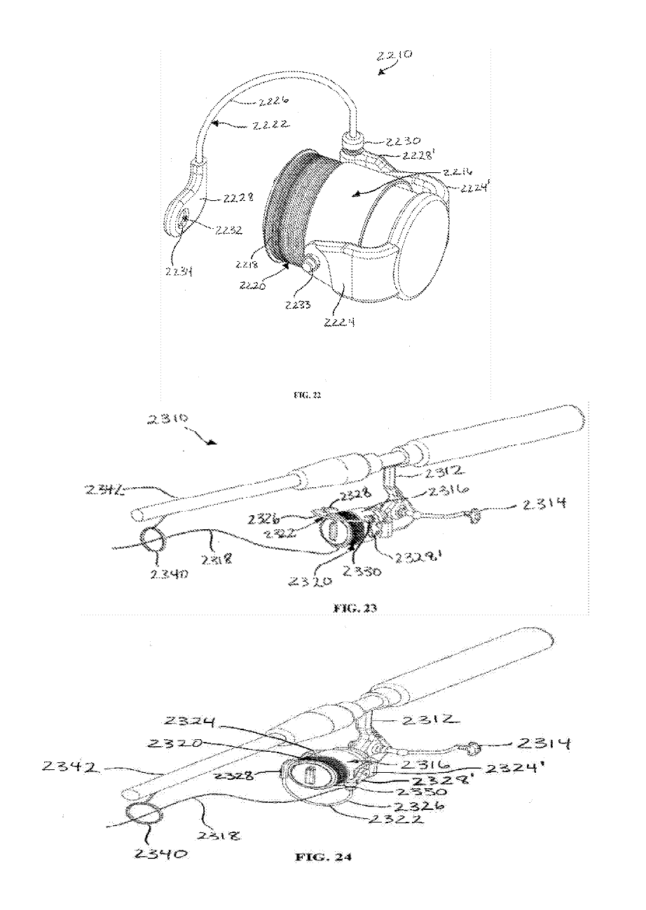

FIG. 23 illustrates the fishing reel 2310 in use with a fishing rod 2342 and rotating crank handle 2314. The bail wire 2326 is in the open position with fishing line 2318 being put through eyelet 2340. A user may use the fishing reel 2310 in this manner for rigging the fishing line or casting. It should be noted that if the bail wire of FIG. 23 was closed, the fishing line could be in the correct position relative to the bail wire 2326. In other words, the fishing line would be underneath the bail wire as shown in FIG. 24.

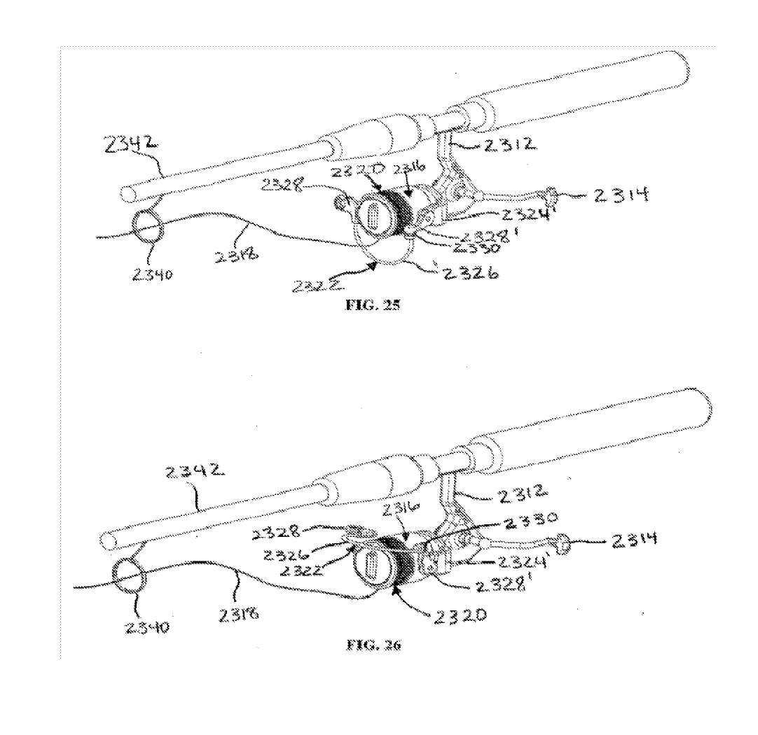

FIG. 25 illustrates fishing reel 2310 with bail wire 2326 being detached from rotor mount 2324 because the fishing line 2318 is in an improper position with the line 2318 failing to pass under the bail wire 2326 and failing to have the ability to be in contact with the line guide 2330. The bail ear 2328 may be easily detached according to any embodiment of the invention in order to re-position the bail wire 2326 such that the wire 2326 comes into contact with guide 2330 to allow for proper reeling when the bail ear 2328 is reattached to the rotor mount 2324 and the bail wire 2326 is in the closed position.

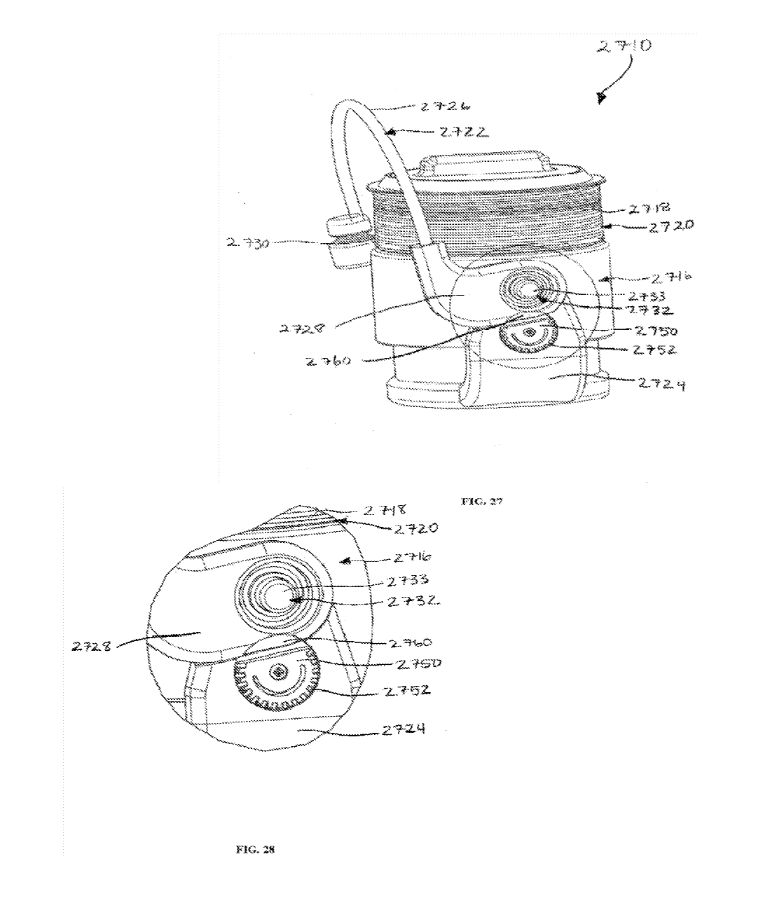

FIG. 26 illustrates the fishing reel 2310 with bail wire 2326 and bail ear 2328 being detached from rotor mount 2324 and the bail wire 2326 being in an open position. FIG. 25 therefore shows the situation where the fishing line 2318 may have been in the incorrect position relative to the bail wire 2326. A user may use the fishing reel in this manner when wanting to re-position the fishing line 2328 properly under the bail wire 2326 to effectuate proper reeling when the bail wire 2326 is in the closed position. Upon detaching the bail ear 2328 from the rotor mount 2340, the user moved the fishing line 2318 under the bail wire 2326. A user with the reel rigged as in FIG. 26 would now need only to reattach the bail ear 2328 to the rotor mount 2324 to resume fishing. This is shown in FIG. 24, which illustrates the fishing reel 2310 with bail wire 2326 being attached to rotor mount 2324. The fishing line 2318 is shown in the proper reeling position, with the fishing line 2318 being in contact with guide 2330 and being pulled through eyelet 2340. Bail wire 2326 is in a closed position, thus allowing the user to properly reel in fishing line 2318.

FIGS. 27 through 37 are illustrations of a fishing reel 2710 according to a bail lock embodiment of the invention. The embodiment of FIGS. 27 through 37 is similar to the fishing reel of FIG. 22 except as provided below. Like structure from FIG. 22 repeated in FIGS. 27 through 37 includes reference numerals in the 2700s, with the last two digits the same. It should be noted that any of the embodiments illustrated in FIGS. 1-22 may be configured to have the bail lock features disclosed below.

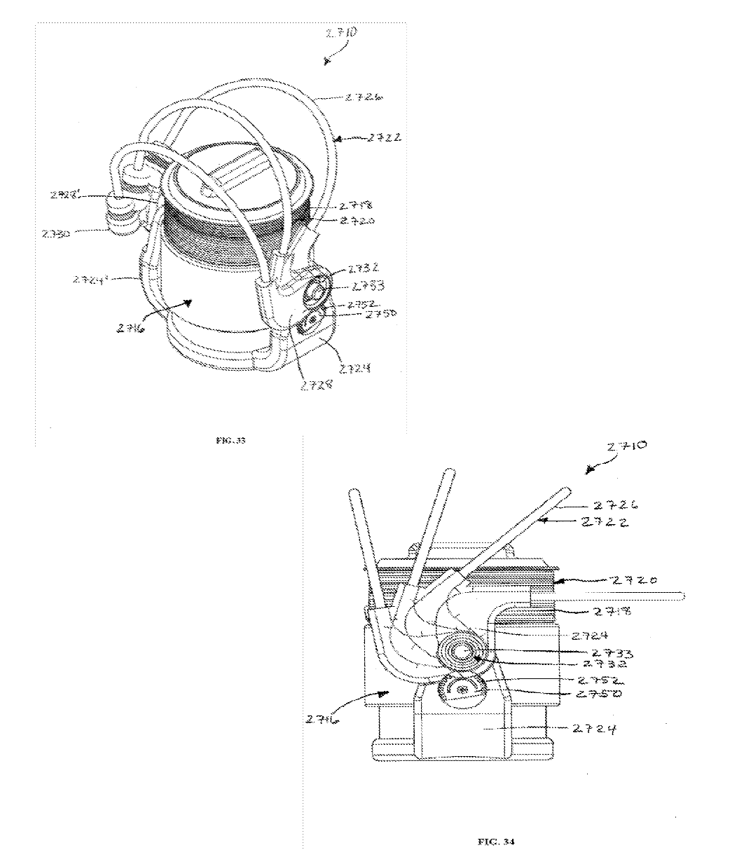

A bail assembly 2722 of a reel 2710 includes a substantially U-shaped bail wire 2726 that is connected to a pair of bail ears 2728, 2728′. The bail wire 2726 and bail ears 2728, 2728′ may be formed from a metal, a plastic, a composite material, or other conventional rigid or flexible material, as desired. The bail ears 2728, 2728′ are pivotally connected to the rotor mounts 2724, 2724′, respectively, so that the bail wire 2726 and bail ears 2728, 2728′ can be pivoted between an open position to facilitate casting, and a closed position to facilitate reeling the fishing line 2718 back onto the spool 2722 (shown in FIGS. 33 and 24). The bail ear 2728 includes an attachment device 2732 that in this case is the push button attachment device of FIG. 22. However, any of the previously described attachment devices 32, 22, 1232, 1432, 1732, 2032, 2232 or similar attachment devices can be used to release the bail ear 2728 from the rotor mount 2724 without departing from the scope and spirit of the invention disclosed herein.

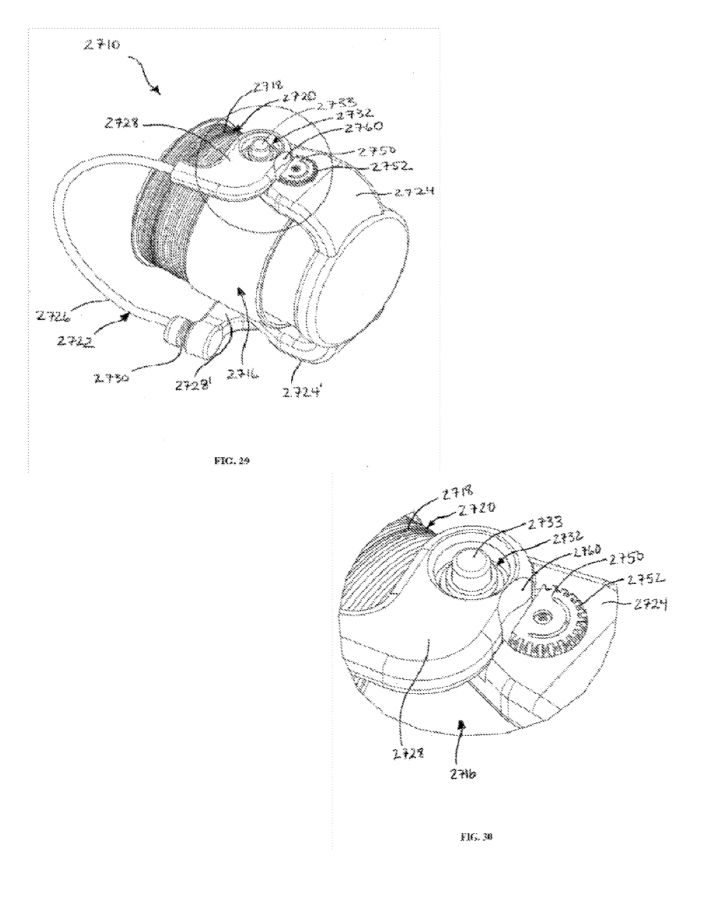

FIGS. 27 through 37 show a cam 2750, which is positioned along the surface of rotor mount 2724, with FIGS. 28 and 30 providing a close up view of a bail attachment device 2732 and a bail lock using cam 2750. The cam 2750 is attached to the rotor mount 2724 such that it can be turned in either a clockwise or counter clockwise direction in order to engage a surface of the ear 2728 to prevent the movement of ear 2728 relative to the rotor mount 2724, thereby preventing the bail wire 2726 from moving from the open position as shown into a closed position (shown in FIGS. 33 and 34). An open position can be described as when the bail wire 2726 is in a substantially parallel position with the longitudinal plane or axis of the spool 2720, whereas the closed position can be described as when the bail wire 2726 is in a substantially perpendicular position to the longitudinal plane or axis of the spool 2720.

Cam 2750 may prevent the movement or rotation of ear 2728 by a number of methods. FIGS. 29 and 30 show the bail ear 2728 having a cut out 2760, which is adapted to receive a portion of the cam surface such that the portion of the cam surface fits flush within cut out 2760. Cam 2750 may have teeth or ribs 2752 in order to further hold the cam 2750 in place within the cut out 2760 and to further allow the user to have a grip on the cam 2750 for turning. In another embodiment, bail ear 2728 contains no cut out and cam 2750 acts on the bail ear 2728 by depressing a portion of the ear 2728 such that it is prevented from rotation, similar to a braking action when the cam 2750 causes friction on the bail ear 2728 when engaged. Cam 2750 may be rotatably affixed to rotor mount 2724 such as with a screw or rivet. Cam 2750 may be any shape, such as circular, triangular, or rectangular with or without a cut out. As evident from FIGS. 27 through 37, the cam 2750 interacts with the cut out section 2760 to prevent the movement of the cut out section 2760 relative to the cam 2750 much like fitting together pieces of a puzzle.

FIGS. 27 and 29 depict a view of fishing reel 2710. FIGS. 28 and 30 show close up views of the cam 2750 bail lock mechanism of FIGS. 27 and 29, respectively. A second rotor mount 2728′ can be seen in FIG. 29, which is attached to bail wire ear 2728′. Cam 2750 is shown in a disengaged position with the curved surface of the cam 2750 positioned downwards and the straight surface of the cam 2750 positioned upwards in a direction facing the cut out 2760 of ear 2728. When casting the fishing rod, the user may desire to keep the cam 2750 in the disengaged position in order to freely switch from an open casting position to a closed or reeling position.

Alternatively, a user may wish to keep cam 2750 in an engaged position to lock the bail wire 2726 in the open position when rigging the fishing rod or when transferring fishing line 2718 from a bulk spool to the fishing reel spool 2720. When the cam 2750 is in this disengaged position, the bail wire 2726 may be accidentally move from the open to closed position due to a bump or unintended force put on the bail wire 2726 when a user is rigging the fishing line 2718, thereby causing tension in the fishing line 2718 and preventing the user from freely pulling line off of the spool. In such cases, the user must again open the bail wire 2726 in order to continue rigging the fishing rod or transferring fishing line 2718 onto the spool 2720.

In the case of large spinning reels used for wade fishing or deep sea fishing, the weight of the bail wire itself may be enough that the momentum of casting causes the bail assembly to move to a closed position. This prematurely causes the spooling out of the line to cease and can cause the bait to come off the line. The bail lock mechanism prevents this from occurring. The bail lock mechanism is a more recent need based on the objective of reel manufacturers to develop more sophisticated spinning reels in which the bail assembly can be easily transitioned from the open position during casting to the closed position during reeling. Anglers prefer a bail closing mechanism that has little resistance to closing the bail assembly. Typically, after the angler casts out the line, the angler uses the crank to turn the rotor, which causes an internal mechanism to move the bail assembly from an open position to a closed position. The angler wants that internal mechanism to provide as little resistance as possible. While these mechanisms now may be very smooth and show little resistance, they do not necessarily and reliably hold open the bail assembly during casting of heavy bail assemblies. The bail lock mechanism addresses this concern as well as the desire to reliably maintain the bail assembly in an open position during rigging of a line.

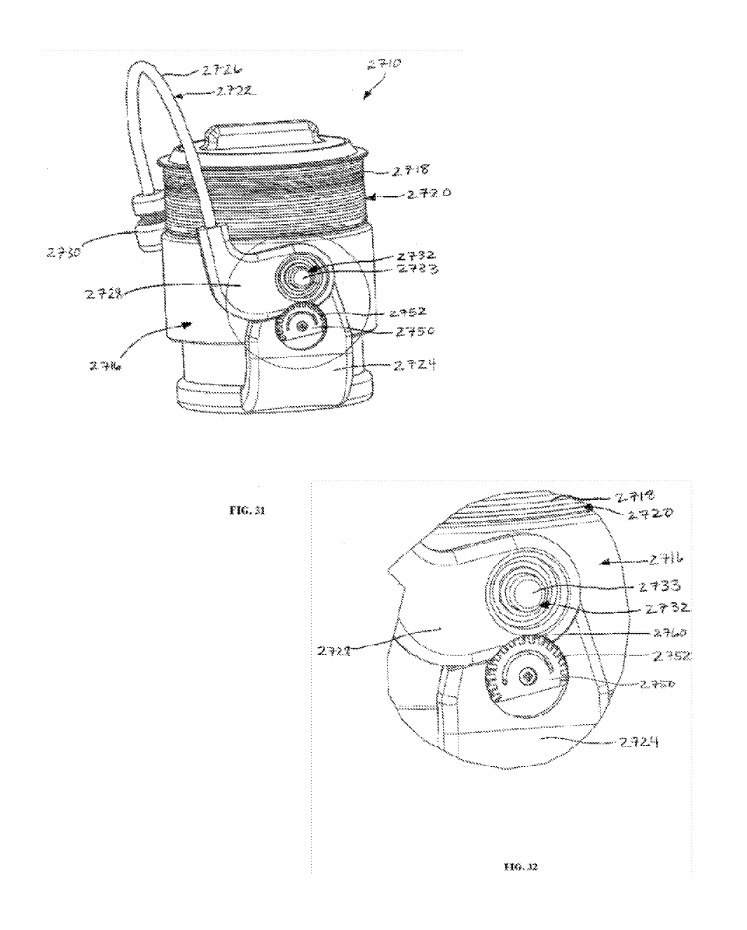

FIG. 31 depicts cam 2750 in the engaged position, with the curved surface of the cam 2750 fitting within cut out 2760 of ear 2728. FIG. 32 shows a close up view of the bail lock mechanism of FIG. 31. A user may use fishing reel 2710 with cam 2750 in the engaged position in order to prevent the bail wire 2760 from accidentally being closed as described above and with respect to FIGS. 27 and 29. The shapes of the cut out 2760 and the cam 2750, and the pivoting movement of the ear 2728 relative to the cam 2750 causes an interaction that prevents the bail assembly and bail wire 2726 from moving from the open position to the closed position when the cam 2750 is engaged in the cut out 2760. The teeth 2752 create additional resistance against the inner surface of cut out 2760 such that ear 2728 is prevented from rotating when the bail wire 2726 or bail assembly 2722 is subjected to an accidental bump or unintended force. The teeth 2752 may be on an outer surface of the cam 2750 to assist the user in moving the cam 2750 or may extend to an edge surface for interacting with the cut out surface 2760. Cam 2750 sits in a space that is carved out of the surface of rotor mount 2724 using known methods.

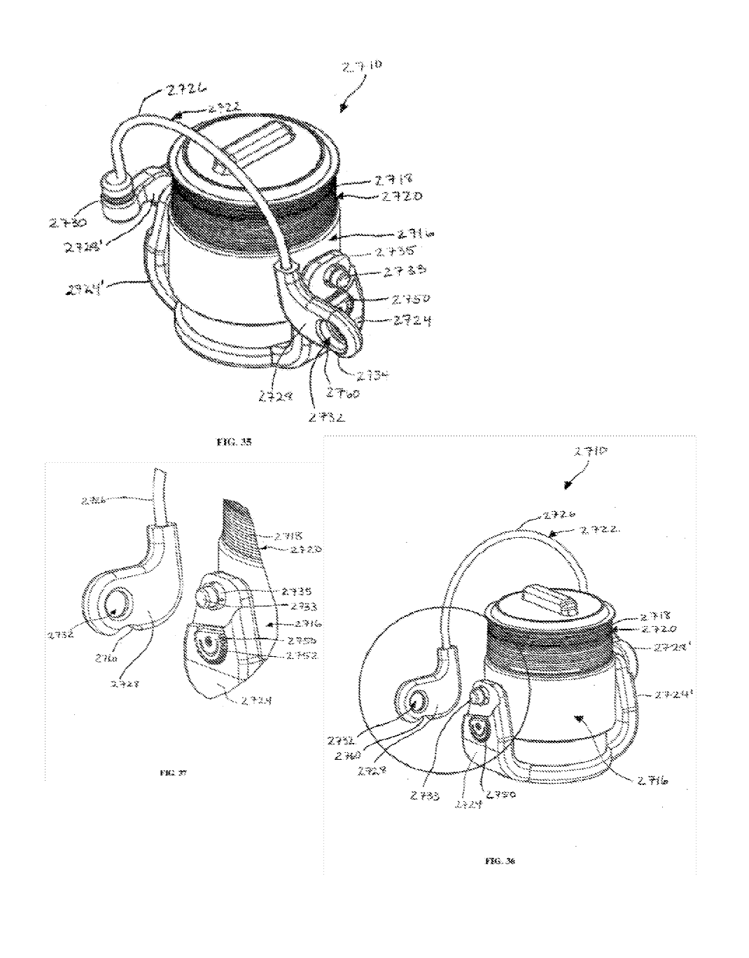

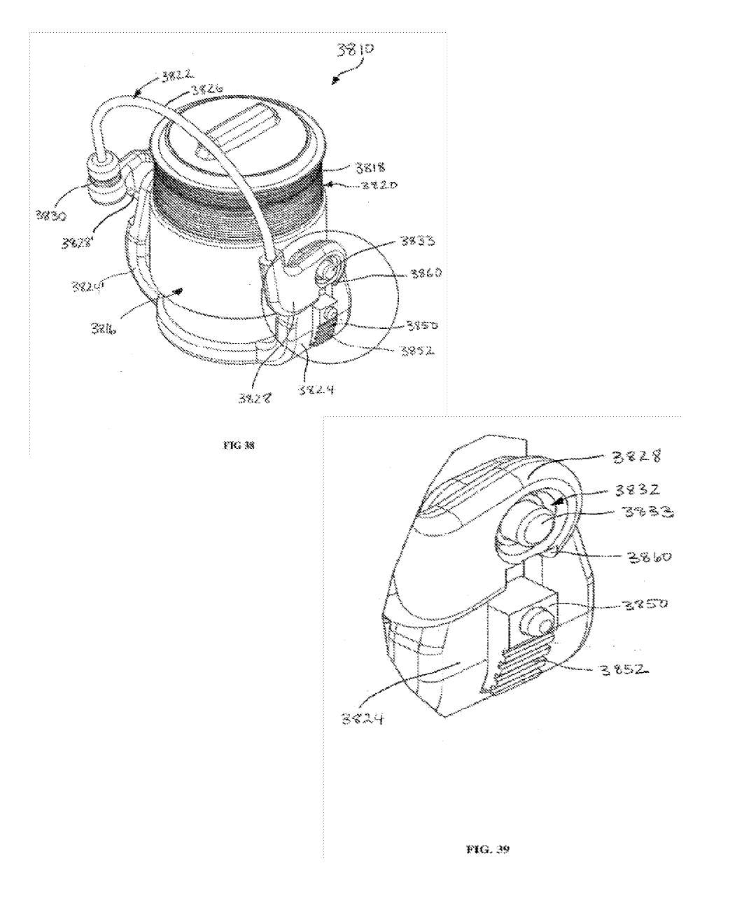

FIGS. 35 through 37 depict the fishing reel 2710 with ear 2728 being in a detached position from rotor mount 2724 and cam 2750 in the disengaged position. FIG. 37 is a close-up view of the circled section in FIG. 36. Rotor mount 2724 includes a housing 2735 that is adapted to fit an attachment device 2732 such as a button 2733. The housing 2735 may be of any shape to conform with the shape of the attachment device 2732, such as square, circular, and/or oval. FIG. 22 depicts the attachment device 2732 shown in FIGS. 27 through 37 without the cam 2750. The portion of the attachment device 2732 on the bail ear 2728 is an opening 2734 within the bail ear 2728. The opening 2734 is designed to couple with the portion 2733 of the attachment device 2732 on the rotor mount 2724 when the bail ear 2728 is in the attached position. The housing 2735 may contain one or more protrusions 2733 adapted to fit the surface of opening 2734, thus allowing for a snap fit attachment and detachment of ear 2728 from rotor mount 2724 as is known in the art.

FIGS. 38 through 41 are a fishing reel 3810 according to another embodiment of the invention. The embodiment of FIGS. 38 through 41 are similar to the fishing reel of FIGS. 27 through 37 except as provided below. Like structure from FIGS. 27 through 37 repeated in FIGS. 38 through 41 includes reference numerals in the 3800s, with the last two digits the same.

A bail assembly 3822 of a reel 3810 includes a substantially U-shaped bail wire 3826 that is fixedly connected to a pair of bail ears 3828, 3828′. The bail wire 3826 and bail ears 3828, 3828′ may be formed from a metal, a plastic, a composite material, or other conventional rigid or flexible material, as desired. The bail ears 3828, 3828′ are pivotally connected to the rotor mounts 3824, 3824′, respectively, so that the bail wire 3826 and bail ears 3828, 3828′ can be pivoted between an open position to facilitate casting, and a closed position to facilitate reeling the fishing line 3818 back onto the spool 3822 (shown in FIGS. 33 and 24). The bail ear 3828 includes an attachment device 3832 that in this case is the push button attachment device of FIG. 22. However, any of the previously described attachment devices 32, 22, 1232, 1432, 1732, 2032, 2232 or similar attachment devices can be used to release the bail ear 3828 from the rotor mount 3824 without departing from the scope and spirit of the invention disclosed herein.

FIGS. 38 through 41 show a sliding button 3850, which is positioned along the surface of rotor mount 3824 with a bail attachment device 3832 and a bail lock using sliding button 3850. The sliding button 3850 is attached to the rotor mount 3824 such that it can be pressed and moved in a direction substantially parallel to the longitudinal axis of the reel 3810 in order to engage a surface of the ear 3828 to prevent the movement of ear 3828 relative to the rotor mount 3824, thereby preventing the bail wire 3826 from moving from the open position as shown into a closed position (shown in FIGS. 33 and 34).

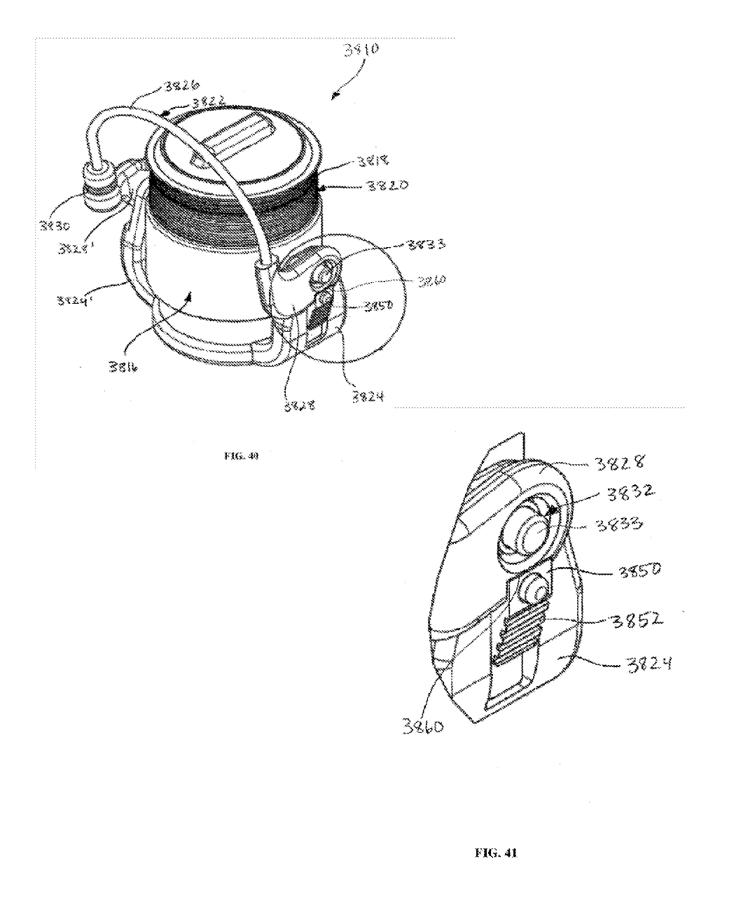

Sliding button 3850 may prevent the movement or rotation of ear 3828 by a number of methods. FIGS. 38 and 39 show the bail ear 3828 having a cut out 3860, which is adapted to receive a portion of the sliding button surface such that the portion of the sliding button surface fits flush within cut out 3860. Sliding button 3850 may have teeth or ribs 3852 on an outer surface in order to further allow the user to have a grip on the sliding button 3850 for pressing and moving. In another embodiment, bail ear 3828 contains no cut out and sliding button 3850 acts on the bail ear 3828 by depressing a portion of the ear 3828 such that it is prevented from rotation, similar to a braking action when the sliding button 3850 causes friction on the bail ear 3828 when engaged. Sliding button 3850 may be affixed to rotor mount 3824 such as with a screw or rivet with a means of allowing movement along the rotor mount in the direction substantially parallel to the longitudinal axis of the reel. Sliding button 3850 may be any shape, such as circular, triangular, or rectangular with or without a cut out. As evident from FIGS. 38 through 41, the sliding button 3850 interacts with the cut out section 3860 to prevent the movement of the cut out section 3860 relative to the sliding button 3850 much like fitting together pieces of a puzzle.

FIG. 38 depicts a view of fishing reel 3810. FIG. 39 shows a close up view of the sliding button 3850 bail lock mechanism of FIG. 38. A second rotor mount 3828′ can be seen in FIG. 38, which is attached to bail wire ear 3828′. Sliding button 3850 is shown in a disengaged position with the sliding button 3850 positioned at the bottom end of the rotor mount 3824. When casting the fishing rod, the user may desire to keep the sliding button 3850 in the disengaged position in order to freely switch from an open casting position to a closed or reeling position.

Alternatively, a user may wish to keep sliding lock 3850 in an engaged position to lock the bail wire 3826 in the open position when rigging the fishing rod or when transferring fishing line 3818 from a bulk spool to the fishing reel spool 3820. When the sliding button 3850 is in this disengaged position, the bail wire 3826 may be accidentally move from the open to closed position due to a bump or unintended force put on the bail wire 3826 when a user is rigging the fishing line 3818, thereby causing tension in the fishing line 3818 and preventing the user from freely pulling line off of the spool. In such cases, the user must again open the bail wire 3826 in order to continue rigging the fishing rod or transferring fishing line 3818 onto the spool 3820.

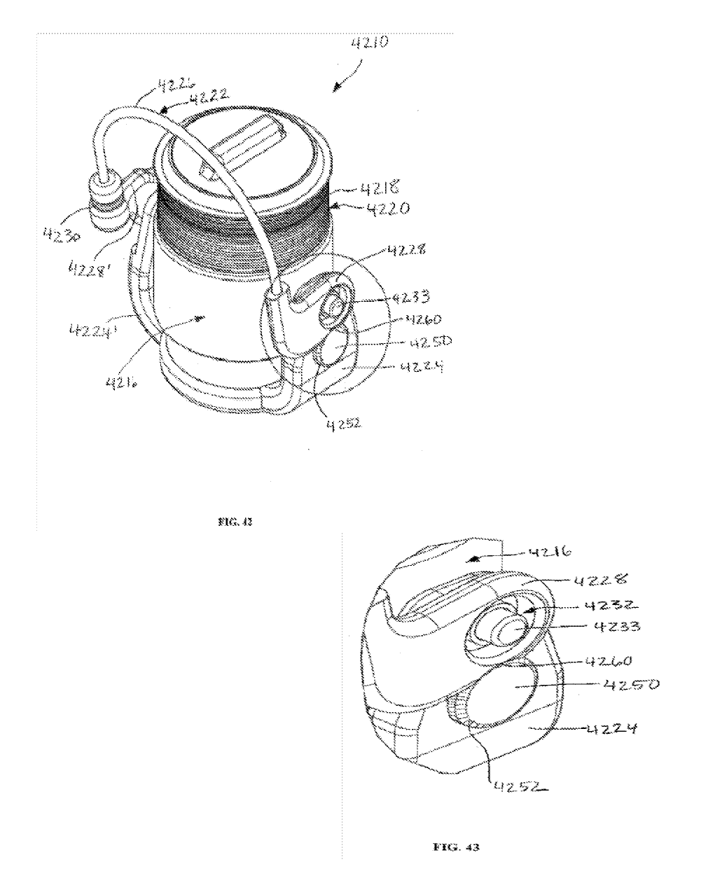

FIG. 40 depicts the sliding button 3850 in the engaged position, with the upper end of the sliding button 3850 fitting within cut out 3860 of ear 3828. FIG. 41 shows a close up view of the sliding button 3850 bail lock mechanism of FIG. 40. A user may use fishing reel 3810 with sliding button 3850 in the engaged position in order to prevent the bail wire 3826 from accidentally being closed as described with respect to FIG. 38. The shapes of the cut out 3860 and the sliding button 3850, and the pivoting movement of the ear 3828 relative to the sliding button 3850 causes an interaction that prevents the bail wire 3826 from moving from the open position to the closed position when the sliding button 3850 is engaged in the cut out 3860. The teeth 3852 may be on an outer surface of the sliding button 3850 to assist the user in moving the sliding button 3850 or may extend to an edge surface for interacting with the cut out surface 3860. The sliding button 3850 sits in a space that is carved out of the surface of rotor mount 3824 using a method known to one of ordinary skill in the art.

FIGS. 42 and 43 are a fishing reel 4210 according to another embodiment of the invention. The embodiment of FIGS. 42 and 43 are similar to the fishing reel of FIGS. 38 through 41 except as provided below. Like structure from FIGS. 38 through 41 repeated in FIGS. 42 and 43 includes reference numerals in the 4200s, with the last two digits the same.

A bail assembly 4222 of a reel 4210 includes a substantially U-shaped bail wire 4226 that is connected to a pair of bail ears 4228, 4228′. The bail wire 4226 and bail ears 4228, 4228′ may be formed from a metal, a plastic, a composite material, or other conventional rigid or flexible material, as desired. The bail ears 4228, 4228′ are pivotally connected to the rotor mounts 4224, 4224′, respectively, so that the bail wire 4226 and bail ears 4228, 4228′ can be pivoted between an open position to facilitate casting, and a closed position to facilitate reeling the fishing line 4218 back onto the spool 4222 (shown in FIGS. 33 and 24). The bail ear 4228 includes an attachment device 4232 that in this case is the push button attachment device of FIG. 22. However, any of the previously described attachment devices 32, 22, 1232, 1432, 1732, 2032, 2232 or similar attachment devices can be used to release the bail ear 4228 from the rotor mount 4224 without departing from the scope and spirit of the invention disclosed herein.

FIGS. 42 and 43 show a spring return push bottom 4250, which is positioned along the surface of rotor mount 4224 with a bail attachment device 4232 and a bail lock using push button spring return 4250. The spring return push button 4250 is attached to the rotor mount 4224 such that it protrudes outward in a direction substantially perpendicular to the longitudinal axis of the reel 4210 in order to engage a surface of the ear 4228 to prevent the movement of ear 4228 relative to the rotor mount 4224, thereby preventing the bail wire 4226 from moving from the open position as shown into a closed position (shown in FIGS. 33 and 34).

Spring return push button 4250 may prevent the movement or rotation of ear 4228 by a number of methods. FIGS. 42 and 43 show the bail ear 4228 having a cut out 4260, which is adapted to receive a portion of the spring return push button surface such that the portion of the spring return push button surface fits flush within cut out 4260. The spring return push button 4250 may have teeth or ribs 4252 around the circumference of the spring return push button 4250 in order to hold the button in place within the cut out 4260. In another embodiment, bail ear 4228 contains no cut out and spring return push button 4250 acts on the bail ear 4228 by depressing a portion of the ear 4228 such that it is prevented from rotation, similar to a braking action when the spring return push button causes friction on the bail ear 4228 when engaged. The spring return push button 4250 may be affixed to rotor mount 4224 such as with a screw, rivet, weld or suitable mounting means such that it may be pressed in or out of the rotor mount in the direction substantially perpendicular to the longitudinal axis of the reel. The spring return push button 4250 may be any shape, such as circular, triangular, or rectangular with or without a cut out. As evident from FIGS. 42 and 43, the spring return push button 4250 interacts with the cut out section 4260 to prevent the movement of the cut out section 4260 relative to the spring return push button 4250 much like fitting together pieces of a puzzle.

FIG. 42 depicts a view of fishing reel 4210. FIG. 43 shows a close up view of the spring return push button 4250 bail lock mechanism of FIG. 42. A second rotor mount 4228′ can be seen in FIG. 42, which is attached to bail wire ear 4228′. As shown in FIGS. 42 and 43, the user may wish to keep spring return push button 4250 in an engaged position to lock the bail wire 4226 in the open position when rigging the fishing rod or when transferring fishing line 4218 from a bulk spool to the fishing reel spool 4220.

FIGS. 42 and 43 show the spring return push button 4250 in an engaged position. When casting the fishing rod, the user may desire to keep the push button 4250 in the disengaged position in order to freely switch from an open casting position to a closed or reeling position. The user can move the push button 4250 from the engaged to disengaged position by pressing the button once in a direction substantially perpendicular to the longitudinal axis of the reel 3810, such that it remains depressed within the rotor mount 4224. To re-engage the push button 4250 mechanism, the user again presses the push button until the button protrudes outward and once again locks bail wire 4226 in the open position. Such a spring return push button can be constructed using a method known to one of ordinary skill in the art.

When the spring return push button is in a disengaged position, the bail wire 4226 may be accidentally moved from the open to closed position due to a bump or unintended force put on the bail wire 4226 when a user is rigging the fishing line 4218, thereby causing tension in the fishing line 4218 and preventing the user from freely pulling line off of the spool. In such cases, the user must again open the bail wire 4226 in order to continue rigging the fishing rod or transferring fishing line 4218 onto the spool 4220.

FIG. 42 depicts the push button in the engaged position, with the upper end of the button fitting within cut out 4260 of ear 4228. FIG. 43 shows a close up view of the push button bail lock mechanism of FIG. 42. A user may use fishing reel 4210 with push button spring return 4250 in the engaged position in order to prevent the bail wire 4226 from accidentally being closed, as described with respect to FIG. 42, due to a bump or unintended force put on the bail wire 4226 when a user is rigging the fishing line 4218, thereby causing tension in the fishing line 4218 and preventing the user from freely pulling line off of the spool. The teeth 4252 create additional resistance against the inner surface of cut out 4260 such that ear 4228 is prevented from rotating when the bail wire 4226 or bail assembly 4222 is subjected to an accidental bump or unintended force. The shapes of the cut out 4260 and the push button spring return 4250, and the pivoting movement of the ear 4228 relative to the push button spring return 4250 causes an interaction that prevents the bail wire 4226 from moving from the open position to the closed position when the push button spring return 4250 is engaged in the cut out 4260. The teeth 4252 may be on an outer surface such as the circumference of the push button spring return 4250 to extend to an edge surface for interacting with the cut out surface 4260. The push button spring return 4250 sits in a space that is carved out of the surface of rotor mount 4224 using a method known to one of ordinary skill in the art.

In another embodiment, not show in the illustrations, the rotor mount may contain a toggle or rocker arm button with two ends, a first end that the angler presses and a second end that is moved upward with the button is pressed downward and moves downward when the button is released. The button has a bias (e.g., with a spring mechanism) to have the second end tend to be in a downward position. The button is positioned on the rotor mount such that the first end is pushed in the direction of the rotor mount and the second end is above or against the bail ear. The second end of the button has a surface having a protrusion (e.g., a flange, tab or other extending member) that is in contact with the bail ear and the bail ear has a surface that has two regions, a first region that the button surface slides against and a second region that receives the protrusion on the second end. When the bail assembly is moved to an open position, the protrusion on the second end of the button extends into the second region, e.g., a slot defined by a pair of sharp edges that limits movement of the protrusion thereby limiting rotational movement of the bail ear.

To cast or rig the fishing line in this embodiment, the angler moves the bail assembly from a closed position to an open position. In so doing, the protrusion on the second end of the button rubs against the first region of the bail ear. As the angler continues to move the bail assembly, the protrusion slides into the second region where the interaction between the protrusion and the slot prevent further movement of the bail assembly. The spring bias of the button pushes the protrusion into the slot of the second region. When finished rigging the line or ready to cast, the angler pushes downward on the first end of the button such that the second end of the button moves upward, thereby pulling the protrusion out of the slot of the second region. This permits the bail assembly to move from the open position to the closed position.

It should also be understood that the spinning type reels described herein may have one or both of the bail lock mechanism and the bail release mechanism. For example, in one embodiment the spinning-type reel includes only the bail lock mechanism. In another embodiment the spinning-type reel includes only the bail release mechanism. In yet another embodiment the spinning-type reel includes both the bail lock mechanism and the bail release mechanism. When the reel includes both the bail lock mechanism and the bail release mechanism, the bail lock mechanism may be on the same bail ear and rotor mount as the bail release mechanism. In another embodiment, the bail release mechanism and the bail lock mechanism are on different bail ear and rotor mount.

While several particular forms of the invention have been illustrated and described, it will be apparent that various modifications and combinations of the invention detailed in the text and drawings can be made without departing from the spirit and scope of the invention. For example, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited, except as by the appended claims.

What is claimed is:

1. A spinning-type reel having a bail release mechanism and a manually manipulated bail lock mechanism, the reel comprising:
a rotor having a first rotor mount and a second rotor mount;
a bail assembly attached to said rotor, said bail assembly having a first bail arm attached to the first rotor mount, a second bail arm attached to the second rotor mount, and a bail wire having ends fixedly disposed on the first bail arm and the second bail arm, the bail assembly movable between an open position and a closed position;
a readily releasable attachment device disposed on one of the first bail arm and the second bail arm to readily releasably attach the first bail arm to the first rotor mount or the second bail arm to the second rotor mount, wherein the first bail arm can be readily released from the first rotor mount and reattached to the first rotor mount; and
a bail lock mechanism disposed on the first rotor mount that is movable to interact with the first bail arm when the first bail arm is attached to the first rotor mount such that when the bail assembly is in the open position the bail lock mechanism can be moved to interact with the first bail arm and lock the bail assembly such that the bail assembly remains in the open position and when the bail lock mechanism is moved such that the mechanism does not interact with the first bail arm the bail assembly may be moved into the closed position.

2. The spinning-type reel of claim 1, wherein the readily releasable attachment device comprises a push button mounted on one of the bail arms that interacts with the rotor mount to readily releasably attach the bail arm to the rotor mount.

3. The spinning-type reel of claim 1, wherein the readily releasable attachment device comprises a movable lever mounted on one of the bail arms that interacts with the rotor mount to readily releasably attach the bail arm to the rotor mount.

4. The spinning-type reel of claim 1, wherein the readily releasable attachment device comprises a movable latch extending from one of the bail arms to interact with an opening in the rotor mount to readily releasably attach the bail arm to the rotor mount.

5. The spinning-type reel of claim 1, wherein the bail lock mechanism comprises a movable element disposed on the first rotor mount that is slideable to interact with the first bail arm.

6. The spinning-type reel of claim 1, wherein the bail lock mechanism comprises a movable element disposed on the first rotor mount that is rotatable to interact with the first bail arm.

7. The spinning-type reel of claim 1, wherein the bail lock mechanism comprises a movable element disposed on the first rotor mount that has a first end and a second end with the element having a bias such that the second end interacts with the first bail arm to limit movement of the bail arm.

8. The spinning-type reel of claim 7, wherein the movable element may be moved against its bias to release the second end of the element from the interaction with the first bail arm to permit movement of the bail arm.

9. A spinning type fishing reel having a bail release mechanism and an external, manually manipulated bail lock mechanism, wherein:
the bail release mechanism permits detachment of a bail wire from a rotor mount without the use of a tool such that a fishing line can pass between the bail wire and the rotor mount; and
the bail lock mechanism permits the bail wire to be locked into an open position.

10. The spinning-type reel of claim 9, wherein the reel comprises a bail assembly and a rotor having a first rotor mount and a second rotor mount.

11. The spinning-type reel of claim 10, wherein the bail assembly is attached to the rotor, the bail assembly having a first bail arm attached to the first rotor mount, a second bail arm attached to the second rotor mount, and a bail wire having ends fixedly disposed on the first bail arm and the second bail arm, the bail assembly movable between an open position and a closed position.

12. The spinning-type reel of claim 11, wherein the readily releasable attachment device is disposed on one of the first bail arm and the second bail arm to readily releasably attach the first bail arm to the first rotor mount or the second bail arm to the second rotor mount, wherein the first bail arm can be readily released from the first rotor mount and reattached to the first rotor mount.

13. The spinning-type reel of claim 12, wherein the bail lock mechanism is disposed on the first rotor mount and is movable to interact with the first bail arm when the first bail arm is attached to the first rotor mount such that when the bail assembly is in the open position the bail lock mechanism can be moved to interact with the first bail arm and lock the bail assembly such that the bail assembly remains in the open position and when the bail lock mechanism is moved such that the mechanism does not interact with the first bail arm the bail assembly may be moved into the closed position.

14. The spinning-type reel of claim 13, wherein the readily releasable attachment device comprises a push button mounted on one of the bail arms that interacts with the rotor mount to readily releasably attach the bail arm to the rotor mount.

15. The spinning-type reel of claim 13, wherein the readily releasable attachment device comprises a movable lever mounted on one of the bail arms that interacts with the rotor mount to readily releasably attach the bail arm to the rotor mount.

16. The spinning-type reel of claim 13, wherein the readily releasable attachment device comprises a movable latch extending from one of the bail arms to interact with an opening in the rotor mount to readily releasably attach the bail arm to the rotor mount.

17. The spinning-type reel of claim 13, wherein the bail lock mechanism comprises a movable element disposed on the first rotor mount that is slideable to interact with the first bail arm.

18. The spinning-type reel of claim 13, wherein the bail lock mechanism comprises a movable element disposed on the first rotor mount that is rotatable to interact with the first bail arm.

19. The spinning-type reel of claim 13, wherein the bail lock mechanism comprises a movable element disposed on the first rotor mount that has a first end and a second end with the element having a bias such that the second end interacts with the first bail arm to limit movement of the bail arm.

20. The spinning-type reel of claim 19, wherein the movable element may be moved against its bias to release the second end of the element from the interaction with the first bail arm to permit movement of the bail arm.
